(19) United States
(12) Patent Application Publication
(10) Pub. No.: US 2024/0141111 A1
(43) Pub. Date: May 2, 2024

(54) SILICONE-POLYOLEFIN HYBRID ELASTOMERS

(71) Applicants: DOW SILICONES CORPORATION, Midland, MI (US); DOW GLOBAL TECHNOLOGIES LLC, Midland, MI (US)

(72) Inventors: Dongchan AHN, Midland, MI (US); Noel Mower CHANG, Midland, MI (US); Marc-Andre COURTEMANCHE, Midland, MI (US); Zachary KEAN, Midland, MI (US); Thomas H. PETERSON, Midland, MI (US)

(21) Appl. No.: 18/276,440

(22) PCT Filed: Feb. 10, 2022
(86) PCT No.: PCT/US2022/015923

§ 371 Date: Aug. 8, 2023

Related U.S. Application Data
(60) Provisional application No. 63/147,866, filed on Feb. 10, 2021.

(51) Int. Cl. C08G 77/26; C08G 77/08; C08G 77/388; C08K 5/14; C08L 23/06; C08L 23/26

(52) U.S. Cl. CPC C08G 77/26; C08G 77/08; C08G 77/388; C08K 5/14; C08L 23/06; C08L 23/26; C08L 2205/02; C08L 2205/03

(57) ABSTRACT

A silicone-polyolefin composition is disclosed. The silicone-polyolefin composition comprises (A) a polysiloxane, (B) a functionalized polyolefin, and (C) a curable silicone elastomer component. The polysiloxane (A) comprises an average of at least one functional group X per molecule, and the functionalized polyolefin (B) comprises an average of at least one functional group Y per molecule, where the functional group X and functional group Y are reactable to form a bond therebetween. A silicone-polyolefin blend, a curable composition comprising the silicone-polyolefin blend, a cured product of the curable composition, and methods of preparing the silicone-polyolefin blend, curable composition, and cured product are also disclosed.

### CROSS REFERENCE TO RELATED APPLICATIONS

This application claims priority to and all advantages of U.S. Provisional Patent Application No. 63/147,866 filed on 10 Feb. 2021, the content of which is incorporated herein by reference.

### FIELD OF THE INVENTION

The present disclosure relates generally to silicone compositions and, more specifically, to a hybrid silicone-polyolefin composition and related curable compositions and cured products.

### DESCRIPTION OF THE RELATED ART

Silicones are polymeric materials used in numerous commercial applications, primarily due to significant advantages they possess over their carbon-based analogues. More particularly referred to as polymerized siloxanes or polysiloxanes, silicones include an inorganic silicon-oxygen backbone chain (—Si—O—Si—O—Si—O—) having organic side groups attached to the silicon atoms. Organic side groups may be used to link two or more of these backbones together. By varying the —Si—O— chain lengths, side groups, and cross-linking, silicones can be synthesized with a wide variety of properties and compositions, with silicone networks varying in consistency from liquid to gel to rubber to hard plastic. Silicone and siloxane-based materials are utilized in myriad end use applications and environments, including as components in a wide variety of industrial, home care, and personal care formulations.

The most common silicone materials are based on the linear organopolysiloxane polydimethylsiloxane (PDMS), a silicone oil, followed by those based on silicone resins formed with branched and cage-like oligosiloxanes. Many of these materials enable unique technologies by providing enhanced performance and benefits due to inherent attributes of organopolysiloxane, including low-loss and stable optical transmission capabilities, high thermal and oxidative stabilities, and biocompatibility.

Unfortunately, despite widespread success in numerous technologies, the use of -silicone materials in certain applications remains limited, if even practicable, due to less-desirable attributes of many conventional siloxanes, such as their weak mechanical properties, which may manifest in materials with poor or unsuitable characteristics such as low tensile strength, low tear strength, etc. As such, carbon-based polymers, such as those based on polyolefin, polyacrylate, and polyurethane resins, are frequently employed in applications that could otherwise benefit from particular inherent attributes of silicones. Complicating matters further, conventional siloxanes are incompatible with most carbon-based polymers, typically due to immiscibility and/or exhibiting antagonistic properties with respect to one another.

### BRIEF SUMMARY

A silicone-polyolefin composition (the “composition”) is provided. The composition comprises (A) a polysiloxane comprising an average of at least one functional group X per molecule, (B) a functionalized polyolefin comprising an average of at least one functional group Y per molecule, and (C) a curable silicone elastomer component. The functional group X of the polysiloxane (A) and the functional Y of the functionalized polyolefin (B) are reactable to form a bond therebetween.

A method of preparing a silicone-polyolefin blend (the “preparation method”) is also provided. The preparation method comprises combining the polysiloxane (A), the functionalized polyolefin (B), and the curable silicone elastomer component (C) to prepare the silicone-polyolefin composition, and reacting the polysiloxane (A) and the anhydride-functional polyolefin (B) in the presence of the curable silicone elastomer component (C), thereby preparing the silicone-polyolefin blend.

A silicone-polyolefin blend prepared according to the preparation method is also provided.

A curable composition is further provided. The curable composition comprises the silicone-polyolefin blend and a curing agent.

A cured product of the curable composition, and a method of preparing the cured product, are also provided.

### DETAILED DESCRIPTION OF THE INVENTION

A silicone-polyolefin composition (the “composition”) is provided herein. As will be understood from the description herein, the composition provides a hybrid composition that contains both silicone and polyolefin components, and may be prepared and used without the aid of solvent. As silicone and polyolefin components are generally understood to be immiscible or otherwise incompatible with one another, the particular compounds and conditions utilized provide unique hybrid materials that exhibit desirable characteristics and properties that may be unobtainable with conventional methods and materials. Likewise, the composition may be exploited as a platform for efficient and economical preparation of numerous functional compositions and components thereof, including in some applications that are poorly suited, if even practicable, for use with conventional materials. Indeed, a compatibilized silicone-polyolefin blend, a curable composition prepared therewith, and a cured product prepared therefrom, as well as methods of making each of the same, are also provided herein and illustrated in the examples below.

In view of this disclosure, one of skill in the art will readily appreciate that the unique structural and physical features of the inventive compositions are compatible with useful production techniques, such as melt-blending and reactive extrusion, without certain drawbacks inherent to using such techniques with traditional materials. Additionally, as also described and illustrated herein, the inventive compositions enable the preparation of products with enhanced performance characteristics, including injection moldable articles with improved toughness (e.g. increased tear strength) and chemical resistance (e.g. increased solvent swell resistance), satisfactory elongation and tensile strength, and desirable haptics. Such articles may be specifically employed in consumer products, where specific performance characteristics provided by conventional materials are often mutually exclusive, and enhancing any one property may decrease the positive tactual experience of a user.

The silicone-polyolefin composition generally includes (A) a polysiloxane, (B) a functionalized polyolefin, and (C) a curable silicone elastomer component. The polysiloxane (A) comprises an average, per molecule, of at least one functional group X, and the functionalized polyolefin (B) comprises an average, per molecule, of at least one functional group Y. In some embodiments, the polysiloxane (A) comprises an average of at least two functional groups X per molecule. In these or other embodiments, the functionalized polyolefin (B) comprises an average of at least two functional groups Y per molecule. As will be understood in view of the description and examples herein, the functional group X of the polysiloxane (A) and the functional group Y of the functionalized polyolefin (B) are reactable (e.g. via additive functional reaction) to form a bond therebetween, i.e., to couple the polysiloxane (A) and the functionalized polyolefin (B).

The polysiloxane (A), functionalized polyolefin (B), and curable silicone elastomer component (C) are described in turn below, along with additional compounds that may be present in the silicone-polyolefin composition, which may be collectively referred to herein as the “components” of the silicone-polyolefin composition (i.e., “component (A)”, “component (B)”, “component (C)”, etc., respectively) or, likewise, as “compound(s),” and/or “reagent(s)” (A), (B), and/or (C), etc.

As introduced above, the silicone-polyolefin composition comprises the polysiloxane (A). As understood by those of skill in the art, polysiloxanes are silicon-based compounds comprising a siloxane backbone, i.e., an at least semi-contiguous chain composed of inorganic silicon-oxygen-silicon groups (i.e., —Si—O—Si—), with organosilicon and/or organic side groups attached to the silicon atoms. Such siloxanes are typically characterized in terms of the number, type, and/or proportion of [M], [D], [T], and/or [Q] units/siloxy groups, which each represent structural units of individual functionality present in polysiloxanes, such as organosiloxanes and organopolysiloxanes. In particular, [M] represents a monofunctional unit of general formula R″₃SiO_{1/2}; [D] represents a difunctional unit of general formula R″₂SiO_{2/2}; [T] represents a trifunctional unit of general formula R″SiO_{3/2}; and [Q] represents a tetrafunctional unit of general formula SiO_{4/2}, as shown by the general structural moieties below:

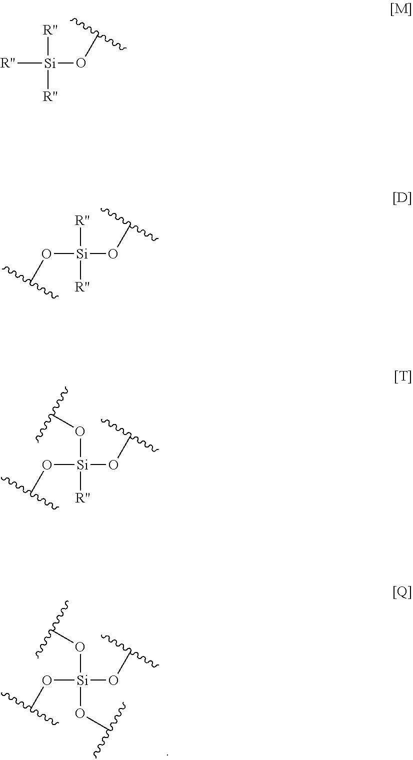

In these general structural moieties, each R″ is independently a monovalent or polyvalent substituent. As understood in the art, specific substituents suitable for each R″ are not particularly limited (e.g. may be monoatomic or polyatomic, organic or inorganic, linear or branched, substituted or unsubstituted, aromatic, aliphatic, saturated or unsaturated, etc., as well as various combinations thereof). In typical examples, each R″ is independently selected from hydrocarbyl groups, alkoxy and/or aryloxy groups, and siloxy groups. With regard to hydrocarbyl groups suitable for R″, examples generally include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or otherwise be referred to as, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof. With regard to alkoxy and/or aryloxy groups suitable for R″, examples generally include hydrocarbyl (e.g. alkyl, aryl, etc.) groups bonded to the silicon atom via an oxygen atom (i.e., forming a silyl ether). The hydrocarbyl groups in these examples may include any of the hydrocarbyl groups described above. With regard to siloxy groups suitable for R″, examples generally include siloxy groups represented by any one, or combination, of [M], [D], [T], and/or [Q] units described above.

One of skill in the art understands how [M], [D], [T] and [Q] units, and their relative proportions (i.e., molar fractions) influence and control the structure of siloxanes, and that polysiloxanes in general may be monomeric, polymeric, oligomeric, linear, branched, cyclic, and/or resinous depending on the selection of [M], [D], [T] and/or [Q] units therein. For example, [T] units and/or [Q] units are typically present in siloxane resins, whereas siloxane polymers (e.g. silicones) are typically free from such [T] units and/or [Q] units. [D] units are typically present in both siloxane resins and polymers. One of skill in the art will also appreciate that siloxanes may be named based on the type and proportion of such siloxy units. For example, the siloxane resins referenced above may be characterized as DT resins, MQ resins, MDQ resins, etc. Likewise, siloxanes that are substantially free from branching attributable to [T] units and/or [Q] units are typically referred to as “linear”. However, it will be appreciated that a linear (i.e., MDM-type) siloxane may comprise individual molecules having T and/or Q units and still be considered “linear” based on the average unit formula of the siloxane as a whole.

In general, the polysiloxane (A) comprises a polydiorganosiloxane-containing backbone having at least one functional group X per molecule. Typically, the polysiloxane (A) is substantially linear, alternatively is linear. In such instances, one of skill in the art will appreciate that the polysiloxane (A) is typically free from [T] siloxy units and/or [Q] siloxy units, as described above.

In some embodiments, the polysiloxane (A) has the following general average unit formula:

[XₘR¹₃₋ₘSiO_{1/2}]ₐ[XₙR¹₂₋ₙSiO_{2/2}]_{b},
where X is the functional group defined above, each R¹ is an independently selected hydrocarbyl group, subscript m is independently 1 or 0 in each moiety indicated by subscript a, subscript n is independently 1 or 0 in each moiety indicated by subscript b, and subscripts a and b are each mole fractions such that a+b=1, with the provisos that 0<a<1, 0<b<1, and that the polysiloxane (A) comprises at least one functional group X.

With reference to the general unit formula of the polysiloxane (A) above, hydrocarbyl groups suitable for R¹ are generally exemplified by those described above. Typically, each R¹ is a substituted or unsubstituted hydrocarbyl group having from 1 to 30 carbon atoms. For example, in some embodiments, each R¹ is an independently selected hydrocarbyl group having from 1 to 12, alternatively from 1 to 8, alternatively from 1 to 6, carbon atoms. In some such embodiments, each R¹ is further defined as an alkyl group, aryl group, or combination thereof. For example, in some embodiments, R¹ represents an independently selected substituted or unsubstituted alkyl group. Specific examples of such alkyl groups include methyl groups, ethyl groups, propyl groups (e.g. n-propyl and iso-propyl groups), butyl groups (e.g. n-butyl, sec-butyl, iso-butyl, and tert-butyl groups), pentyl groups, hexyl groups, etc., and the like, as well as derivatives and/or modifications thereof. Examples of derivatives and/or modifications of such alkyl groups include substituted versions thereof, e.g. where a hydroxyl ethyl group will be understood to be a derivative and/or a modification of the ethyl groups described above.

Each R¹ may be the same as or different from any other R¹ of the polysiloxane (A). In certain embodiments, each R¹ is the same as each other R¹ of the polysiloxane (A). For example, in some such embodiments, each R¹ is methyl. In other embodiments, at least one R¹ is different from at least one other R¹ of the polysiloxane (A). For example, in certain embodiments, R¹ is predominantly methyl throughout the polysiloxane (A), with one or more other groups pending from the polydiorganosiloxane backbone in minor amounts (e.g. from the preparation of the polysiloxane (A), environmental reactions or impurities, etc.). In some embodiments, each R¹ is a fluoroalkyl group, i.e. such that the polysiloxane (A) may be further defined or referred to as a fluorosilicone or fluoropolysiloxane.

As introduced above, the polysiloxane (A) comprises, on average, at least one functional group per molecule, as represented by moiety X in the general formula of the polysiloxane (A) above. In some embodiments, however, the polysiloxane (A) comprise an average of at least two functional groups X per molecule.

As described in herein, the functional groups X of the polysiloxane (A) are reactable with the functional groups Y of the functionalized polyolefin (B) to form a bond therebetween. In other words, one functional group X and one functional group Y are capable of reacting together (i.e., via a coupling reaction, cross-linking reaction, etc.), to covalently bond together the polysiloxane (A) and the functionalized polyolefin (B). It is to be understood that terms such as “coupling,” “coupleable,” “reactable,” “cross-linking,” and “cross-linkable” used herein are not intended to imply any directionality to a reaction, but instead will be understood in the customary sense to refer to the coupling facilitated by groups X and Y without inference as to particular reactivity or role in the reaction therebetween. As described herein, in some embodiments, the average molecules of components (A) and/or (B) have at least two groups capable of participating in the coupling reaction, such that a single molecule of the polysiloxane (A) may be, on average, capable of being coupled at least once to two or more molecules of the functionalized polyolefin (B) or, likewise, at least twice to a single molecule of the functionalized polyolefin (B).

In general, each functional group X comprises, alternatively is, a functional group that may participate in the coupling/cross-linking reaction described above. Examples of such functional groups are typically reactive via substitution reaction, addition reaction, coupling reaction, or combinations thereof. Specific examples of such reactions include nucleophilic substitutions, ring-opening additions, alkoxylations and/or transalkoxylations, hydrosilylations, olefin metatheses, condensations, radical couplings and/or polymerizations, and the like, as well as combinations thereof. Accordingly, functional groups X may comprise, or be, a functional group that is hydrosilylatable (e.g. a silicon-bonded hydrogen atom, an olefinically (i.e., ethylenically) unsaturated group, such as an alkenyl group, alkynyl group, etc.), condensable (e.g. a hydroxyl group, a carboxyl group, a carbinol group, an alkoxysilyl group, a silanol group, an amide group, an anhydride group, etc., or a group that may be hydrolyzable and subsequently condensable), displaceable (e.g. a “leaving group” as understood in the art, such as a halogen atom, or other group stable in an ionic form once displaced, or a functional group comprising such a leaving group, such as esters, anhydrides, amides, epoxides, etc.), nucleophilic (e.g. a heteroatom with lone pairs, an anionic or anionizable group, etc., such as a hydroxyl group (e.g. of a carbinol), an amine group, a thiol group, a silanol group, a carboxylic acid group, etc.), electrophilic (e.g. isocyanates, epoxides, etc.), or various combinations thereof.

In some embodiments, at least one, alternatively at least two, alternatively each functional group X is a hydrosilylatable group, and thus selected from olefinically-unsaturated groups (e.g. ethylenically unsaturated groups) and H. In some such embodiments, each hydrosilylatable group represented by X is H, such that the polysiloxane (A) is silicon hydride-functional. In other of such embodiments, each hydrosilylatable group represented by X is an ethylenically unsaturated group.

Examples of ethylenically unsaturated groups generally include substituted or unsubstituted hydrocarbon groups having at least one alkene or alkyne functional group. For example, in certain embodiments, each functional group X comprises, alternatively is, an alkenyl group or an alkynyl group. Specific examples thereof include H₂C═CH—, H₂C═CHCH₂—, H₂C═CHCH₂CH₂—, H₂C═CH(CH₂)₃—, H₂C═CH(CH₂)₄—, H₂C═C(CH₃)—, H₂C═C(CH₃)CH₂—, H₂C═C(CH₃)CH₂CH₂—, H₂C═C(CH₃)CH₂CH(CH₃)—, H₂C═C(CH₃)CH(CH₃)CH₂—, H₂C═C(CH₃)C(CH₃)₂—, HC≡C—, HC≡CCH₂—, HC≡CCH(CH₃)—, HC≡CC(CH₃)₂—, and HC≡CC(CH₃)₂CH₂—. In specific embodiments, each functional group X comprises, alternatively is, a vinyl group.

In embodiments where the functional group X comprises one of the ethylenically unsaturated groups above, it will be appreciated that the functional group X may also comprise a divalent linking group between the ethylenically unsaturated group and a silicon atom of the polysiloxane (A). Examples of such divalent linking groups include divalent versions of the hydrocarbyl groups described above, such as alkyl groups. For example, the functional group X may have the formula H₂C═CH—(CH₂)₅—, which may be considered to represent the alkenyl group H₂C═CHCH₂— with a butylene linking group, the alkenyl group H₂C═CH(CH₂)₄— with a methylene linking group, etc. In certain embodiments, each functional group X comprises, alternatively is a methacryloxy group, such as a silicon-bonded methacryloxyalkyl group.

In some embodiments, at least one, alternatively at least two, alternatively each functional group X comprises, alternatively is, a condensable group, i.e., is capable of participating in a condensation reaction. In specific embodiments, each functional group X comprises a condensable group selected from anhydride groups, amine groups, silanol groups, carbinol groups, and alkoxysilyl groups.

Examples of suitable anhydrides for functional group X generally include anhydrides of monocarboxylic acids (e.g. acetic acid, lactic acid, propanoic acid, pentanoic acid, methacrylic acid, etc.), which may be homoanydrides or mixed anhydrides, as well as polycarboxylic acids such as succinates (i.e., succinic anhydrides), maleates (i.e., maleic anhydrides), phthalates, etc. One of skill in the art will appreciate that various substitution patterns are possible with such anhydrides in terms of linking the same to the silicon atom of the polysiloxane (A). Typically, such anhydrides may be grafted onto a siloxane polymer to prepare the polysiloxane (A), and thus one of skill in the art will understand the applicability of other anhydrides, and carboxylic acids/carboxylates that may also be utilized, e.g. via grafting directly to the polysiloxane (A) or instead via an initial grafting and subsequent reaction to prepare the anhydride. For example, anhydrides containing at least one olefinically unsaturated group, such as alkenylsuccinic anhydrides, bromomaleic anhydride, chloromaleic anhydride, citraconic anhydride, methylnadic anhydride, nadic anhydride, tetrahydrophthalic anhydride, and the like, may be grafted onto a siloxane (e.g. via hydrosilylation). Free radical based grafting schemes may also be used to produce anhydride functional siloxanes from reagents such as maleic anhydride and vinylsiloxanes.

Examples of suitable amines for functional group X generally include primary amino-substituted derivatives of the hydrocarbyl groups described above. For example, functional group X may comprise, alternatively may be, an aminoalkyl group, such as an amino-substituted alkyl group having from 1 to 20 carbon atoms (e.g. aminomethyl, 2-aminoethyl, 3-aminopropyl, 6-aminohexyl, an aminoaryl group (e.g. 4-aminophenyl, 3-(4-aminophenyl) propyl, etc.), or an aminoalkylamino group (e.g. N-(2-aminoethyl)-3-aminopropyl, N-(2-aminoethyl)-3-aminoisobutyl, etc.).

In some embodiments, at least one, alternatively at least two, alternatively each functional group X comprises, alternatively is, a silanol group. In certain embodiments where at least one functional group X comprises a silanol group, the silicon atom of the silanol group is a silicon atom of the backbone of the polysiloxane (A). In other embodiments, at least one X comprises, alternatively is, a moiety of formula -D-SiR¹_{3-c}(OH)_{c}, where each D is a covalent bond, an oxygen atom, or a divalent hydrocarbon group, R¹ is independently selected and defined above, and subscript c is 1, 2, or 3. When subscript c is 3, the silicon atom of the silanol group includes three silicon-bonded hydroxyl groups; when subscript c is 2, the silicon atom of the silanol group includes two silicon-bonded hydroxyl groups; when subscript c is 1, the silicon atom of the silanol group includes two silicon-bonded hydroxyl groups. In certain embodiments, D is an oxygen atom. In other embodiments, D is a divalent hydrocarbon group having from 2 to 18, alternatively from 2 to 16, alternatively from 2 to 14, alternatively from 2 to 16, alternatively from 2 to 12, alternatively from 2 to 10, alternatively from 2 to 8, alternatively from 2 to 6, alternatively from 2 to 4, carbon atoms.

In some embodiments, each functional group X comprises, alternatively is a silicon-bonded hydroxyl group.

In some embodiments, at least one, alternatively at least two, alternatively each functional group X comprises, alternatively is, a carbinol group. Carbinol functional groups bonded to silicon atoms in organopolysiloxanes are distinguished from silanol groups. Specifically, carbinol functional groups include a carbon-bonded hydroxyl group, and silanol functional groups include a silicon-bonded hydroxyl group. Said differently, carbinol functional groups include at least one moiety of formula —COH, whereas silanol functional groups are of formula —SiOH. These functional groups perform differently; for example, silanol functional groups can readily condense, which generally does not occur with carbinol functional groups (at least under the same catalysis of hydrolysis/condensation of silanol functional groups). The carbinol functional groups can be the same as or different from one another.

In certain embodiments, the carbinol functional groups independently include a moiety having the general formula -D¹-O_{d}—(CₑH₂ₑO)_{f}—H, where D¹ is a covalent bond or a divalent hydrocarbon linking group having from 2 to 18 carbon atoms, subscript d is 0 or 1, subscript e is independently selected from 2 to 4 in each moiety indicated by subscript f, and subscript f is from 0 to 500, with the proviso that subscripts d and f are not simultaneously 0.

In some such embodiments, subscript f is at least one, such that at least one of the carbinol functional groups includes a moiety having the general formula:

-D¹-O_{d}—[C₂H₄O]_{g}[C₃H₆O]ₕ[C₄H₈O]ᵢ—H;
where D¹ and subscript d are defined above, 0≤g≤500, 0≤h≤500, and 0≤i≤500, with the proviso that 1≤g+h+i≤500. In these embodiments, the carbinol functional group may alternatively be referred to as a polyether group or moiety, although the polyether group or moiety terminates with —COH, rather than —COR, where R is a monovalent hydrocarbon group, which is the case with certain conventional polyether groups or moieties. As understood in the art, moieties indicated by subscript g are ethylene oxide (EO) units, moieties indicated by subscript h are propylene oxide (PO) units, and moieties indicated by subscript i are butylene oxide (BO) units. The EO, PO, and BO units, if present, may be in block or randomized form in the polyether group or moiety. The relative amounts of EO, PO, and BO units, if present, can be selectively controlled based on desired properties, e.g. hydrophilicity and other properties.

In other embodiments, subscript f is 0 and subscript d is 1 such that at least one of the carbinol functional groups includes a moiety having the general formula: -D¹-OH, where D¹ is described above. In these embodiments, the carbinol functional groups having this general formula are not polyether groups or moieties.

In some embodiments, at least one, alternatively at least two, alternatively each functional group X comprises, alternatively is, an alkoxysilyl group.

In embodiments where at least one X is an alkoxysilyl group, each alkoxysilyl group may independently comprise or be a monoalkoxysilyl group, dialkoxysilyl group, or trialkoxysilyl group, respectively. In particular embodiments, the alkoxysilyl group comprises, alternatively is, a monoalkoxysilyl group. In other embodiments, the alkoxy group comprise, alternatively is, a dialkoxysilyl group. In yet other embodiments, the alkoxysilyl group comprises, alternatively is, a trialkoxysilyl group.

In certain embodiments, the silicon atom of the alkoxysilyl group is a silicon atom of the backbone of the polysiloxane (A). In other embodiments, at least one X comprises, alternatively is, a moiety of formula -D²-SiR¹₃₋ⱼ(OR⁶)ⱼ, where each D² is a covalent bond, an oxygen atom, or a divalent hydrocarbon group, R¹ is independently selected and defined above, subscript j is 1, 2, or 3, and each R⁶ is an independently selected alkyl group having from 1 to 12 carbon atoms. Typically, each R⁶ is an independently selected alkyl group having from 1 to 10, alternatively from 1 to 8, alternatively from 1 to 6, alternatively from 1 to 4, alternatively 1 to 3, alternatively 1 or 2, alternatively 1, carbon atoms.

Specific examples of alkoxysilyl groups include those comprising trimethoxysilyl groups, triethoxysilyl groups, dimethoxyethoxysilyl groups, dimethoxymethyl groups, diethoxymethyl groups, methoxyethoxymethyl groups, dimethylmethoxy groups, dimethylethoxy groups, etc.

In some embodiments, at least one, alternatively at least two, alternatively each functional group X comprises, alternatively is, an epoxy group. Examples of suitable epoxy groups include a 3-glycidoxypropyl group, a 4-glycidoxybutyl group, or similar glycidoxyalkyl (i.e., glycidyloxyalkyl) groups; a 2-(3,4-epoxycyclohexyl)ethyl group, a 3-(3,4-epoxycyclohexyl)propyl group, or similar epoxycyclohexylalkyl groups; a 4-oxiranylbutyl group, and an 8-oxiranyloctyl group. Such epoxy groups may be bonded directly to the polysiloxane (A). Alternatively, a divalent hydrocarbon group may be present in X between the epoxide group and the silicon atom to which X is bonded. In some of these embodiments, the divalent hydrocarbon group comprises, alternatively is, an alkylene group having the general formula —(CH₂)ₖ—, where subscript k is from 2 to 10. In other embodiments, the divalent hydrocarbon group comprises from 2 to 10 carbon atoms and includes at least one ether moiety, i.e., at least one oxygen heteroatom. Such divalent hydrocarbon groups may also be suitable for use as the divalent linking groups described herein (e.g. D, D¹, D², etc.).

With reference to the general unit formula of the polysiloxane (A) above, subscript m is independently 1 or 0 in each moiety indicated by subscript a, subscript n is independently 1 or 0 in each moiety indicated by subscript b. As such, subscripts m and n merely indicate the presence of the functional group X in any particular [M] unit (i.e., as indicated by subscript a) or [D] unit (i.e., as indicated by subscript b). When each subscript m is 0 (i.e., subscript m is 0 in each moiety indicated by subscript a), the polysiloxane (A) comprises at least one pendant functional X (i.e., bonded to a [D] unit). When each subscript n is 0 (i.e., subscript n is 0 in each moiety indicated by subscript b), the polysiloxane (A) comprises at least one terminal functional X (i.e., bonded to an [M] unit). In some embodiments, the polysiloxane (A) is only terminally-functional with respect to the functional groups X, such that subscript n is 0 in each moiety indicated by subscript b. In some such embodiments, the polysiloxane (A) comprises at least two moieties indicated by subscript a, and subscript m is 1 in at least two moieties indicated by subscript a. In other embodiments, the polysiloxane (A) comprises at least one terminal functional group X. In yet other embodiments, the polysiloxane (A) comprises only pendant functionality with respect to the functional groups X, such that subscript m is 0 in each moiety indicated by subscript a, the polysiloxane (A) comprises at least two moieties indicated by subscript b, and subscript n is 1 in at least two moieties indicated by subscript b.

With continued reference to the general unit formula of the polysiloxane (A) above, subscripts a and b are each mole fractions such that a+b=1, with the provisos that 0<a<1 and 0<b<1. It will be appreciated that the moieties indicated by subscripts a and b are generally [M] and [D] siloxy units, respectively. As such, in certain embodiments, the polysiloxane (A) may be defined as an MDM-type polysiloxane. Accordingly, in such embodiments, the polysiloxane (A) may be defined as a linear polysiloxane (or, more simply, “linear siloxane”). Nonetheless, it is to be appreciated that the general formula above may be an average unit formula, i.e., the average formula based on all molecules in the polysiloxane (A). As such, as described above with regard to siloxanes generally, the polysiloxane (A) may comprise a limited amount of branching (e.g. attributable to [T] and/or [Q] units) without departing from the scope of linearity understood by those of skill in the art, even though such units are not included in the general unit formula above. Typically, the polysiloxane (A) is substantially free from, alternatively free from, [T] and/or [Q] units.

In some embodiments, each of the units represented by subscripts a and b are independently selected, and at least two units of the polysiloxane (A) comprise the functional group X. In such embodiments, the preceding general formula for the polysiloxane (A) may be rewritten as the following expanded average unit formula:

[XR¹₂SiO_{1/2}]_{a′}[XR¹SiO_{2/2}]_{b′}[R¹₂SiO_{2/2}]_{b″}[R¹₃SiO_{1/2}]_{a″},
where each X and R¹ are as defined above, subscripts a′, a″, b′, and b″ each indicate the number of corresponding moieties are present in the polysiloxane (A). In this fashion, a′+a″ is equal to number of [M] siloxy units present in the mole fraction represented by subscript a in the general formula above, and b′+b″ is equal to number of [D] siloxy units present in the mole fraction represented by subscript b in the general formula above. For example, in general, a′+a″≥2, a′+b′≥2, and b′+b″≥1. In the specific embodiments described above, where the polysiloxane (A) is only terminally functional, a′=2, b′=0, b″≥1, and a″=0.

In general, the polysiloxane (A) may have a number average degree of polymerization (DP) of from 10 to 10,000. As such, with reference to the preceding expanded formula of the polysiloxane (A), a′+a″+b′+b″ is generally from 10 to 10,000. In some embodiments, the polysiloxane (A) has a DP of from 10 to 1200, alternatively from 50 to 1200. Likewise, in these embodiments, a′+a″+b′+b″ is generally from 10 to 1200, alternatively from 50 to 1200. For example, in some embodiments, the polysiloxane (A) has a DP of from 50 to 1100, alternatively from 50 to 1000, alternatively from 100 to 1000. In specific embodiments, a′ and a″ are each from 0 to 2, typically with a′+a″=2. Subscript b″ may be from 0 to 10,000, such as from 5 to 5,000, alternatively from 50 to 1200, alternatively from 50 to 1100, alternatively from 50 to 1000, alternatively from 100 to 1000. In these or other embodiments, subscript b′ is from 0 to 200, such as from 0 to 10, alternatively from 1 to 10, alternatively from 1 to 8.

In certain embodiments, the polysiloxane (A) has a degree of substitution (DS) of from 1 to 200. It will be appreciated that the DS of the polysiloxane (A) may be represented by the sum of subscripts a′ and b′ in the expanded formula above, i.e., which indicates the number of functional groups X. In some embodiments, the polysiloxane (A) has a DS of from 1 to 100, alternatively from 1 to 50, alternatively from 1 to 20, alternatively from 1 to 10, alternatively from 2 to 10.

In some embodiments, the polysiloxane (A) comprises a molecular weight distribution, as represented by polydispersity index (PDI) (i.e., the weight average molecular weight/number average molecular weight (Mw/Mn), of less than 3, alternatively less than 2.5, alternatively less than 2.25, and at the same time greater than or equal to 1. For example, the polysiloxane (A) may comprise a PDI of from 1 to 3, such as from 1 to 2.5, alternatively from 1.5 to 2.5, alternatively from 1.5 to 2.2, alternatively from 1.8 to 2.2, alternatively of about 2. Methods of determining the PDI for the polysiloxane (A) are known in the art, and generally include weight determinations via rheology, solution viscosity, gel permeation chromatography (GPC), etc., with standards and procedures readily understood and available.

Typically, the polysiloxane (A) utilized in the silicone-polyolefin composition is flowable, i.e., comprises a viscosity low enough to exhibit flow under ambient conditions (e.g. at 25° C.). In some embodiments, the polysiloxane (A) is a liquid at room temperature. In certain embodiments, the polysiloxane (A) exhibits a viscosity of at least 1000 cP, alternatively of at least 3500 cP, at 25° C. (e.g. as determined via viscometer, such as a Brookfield LV DV-E viscometer, equipped with an appropriate spindle).

In certain embodiments, the polysiloxane (A) is further defined as a functionalized polydimethylsiloxane (PDMS), i.e., where each R¹ is methyl. In some such embodiments, the polysiloxane (A) is selected from amine-functional PDMS (i.e., where each functional group X comprises an amine, such as a primary aminoalkyl group) and vinyl-functional PDMS (i.e., where each functional group X comprises, alternatively is, a vinyl group).

In view of the description above, examples of such amine-functionalized PDMS suitable for use in, or as, the polysiloxane (A) will be understood to include terminal and/or pendant amine-functional PDMS oligomers and polymers. However, it will also be understood that, in certain embodiments, the polysiloxane (A) may comprise, alternatively may be, a terminal and/or pendant amine-functional random, graft, or block copolymer or co-oligomer of PDMS and a non-reactive siloxane (e.g. a polyphenylmethylsiloxane, a tris(trifluoropropyl)methylsiloxane, etc.). In this same fashion, examples of vinyl-functionalized PDMS suitable for use in, or as, the polysiloxane (A) include terminal and/or pendant vinyl-functional PDMS oligomers and polymers, as well as random, graft, or block copolymer or co-oligomer of PDMS and a non-reactive. In specific embodiments, the polysiloxane (A) comprises, alternatively is, an aminoalkyl-terminated PDMS, such as an α,ω-aminopropyl-terminated PDMS. In certain embodiments, the polysiloxane (A) comprises, alternatively is, a vinyl-terminated PDMS, such as an α,ω-vinyl-terminated PDMS. In some embodiments, the polysiloxane (A) comprises, alternatively is, is a methacryloylpropyl-terminal PDMS, a silanol-terminal PDMS, a succinic anhydride-terminal PDMS, a SiH-terminal PDMS, a vinyl-terminated PDMS, a mono carbinol-functional PDMS, or an aminopropyl-terminated PDMS.

As introduced above, the silicone-polyolefin composition also comprises the functionalized polyolefin (B). The functionalized polyolefin (B) comprises an average of at least one functional group Y per molecule, e.g. as a substituent of a polyolefin backbone. In some embodiments, the functionalized polyolefin (B) comprises an average of at least two functional group Y per molecule. As described herein, the functional groups Y are reactable with the functional groups X of the polysiloxane (A) to form a bond therebetween. As such, it will be understood that component (B) of the silicone-polyolefin composition generally comprises a polyolefin that is prepared with, obtained with, or otherwise functionalized to include the functional groups Y as substituents. Accordingly, the functionalized polyolefin (B) may comprise, alternatively may be, a terminally-substituted (i.e., a functional group-terminated) polyolefin, a pendantly-substituted polyolefin, or a combination thereof.

In general, polyolefins suitable for the functionalized polyolefin (B) are exemplified by polymers prepared from olefinic monomers, olefinic macromonomer and oligomers, and combinations thereof. Regardless of the actual synthetic route by which the functionalized polyolefin (B) is prepared, one of skill in the art will readily appreciate the scope of the polyolefin component of the functionalized polyolefin (B) in terms of its constituent parts (or theoretical constituent parts), i.e., the olefinic base monomers polymerized to prepare the polyolefin. The term “olefinic” used in the context of the base monomers composing the functionalized polyolefin (B) refers to the presence of an ethylenically unsaturated end group, i.e., which is polymerizable with an ethylenically unsaturated group of other olefinic monomer to provide a polyolefin. In this fashion, it will be understood that a “polyethylene” is a polyolefin derived, or theoretically derivable, from the monomer ethene (ethylene), which is the smallest ethylenically unsaturated compound. Likewise, a polyethylene-methacrylate copolymer is a polyolefin derived, or theoretically derivable, from the comonomers ethylene and methacrylate, with the latter monomer comprising a terminal ethylenically unsaturated group, i.e., an alpha-olefin (e.g. —C═CH₂). As such, it will be appreciated that, in typical embodiments, the functionalized polyolefin (B) comprises a poly-alpha-olefin backbone.

The poly-alpha-olefin backbone of the functionalized polyolefin (B) is not particularly limited, and generally comprises monomeric units derived, or at least theoretically derivable from, an alpha olefin having the general formula R²₂C═CH₂, where each R² is hydrogen or a hydrocarbyl group (i.e., a substituted or unsubstituted hydrocarbyl group), such as any of those described above. For example, in certain embodiments one R² is methyl and the other R² is an esteric carbon, such that the alpha olefin is a methacrylate (e.g. a methyl or ethyl methacrylate, where the other R² is a methyl ester or ethyl ester, respectively). In some embodiments, at least one R² is hydrogen and the alpha olefin has the general formula R²CH═CH₂, where R² is selected from hydrogen and linear or branched hydrocarbyl groups having from 1 to 12, alternatively from 1 to 8, alternatively from 1 to 6, alternatively 1 or 2, carbon atoms. Such hydrocarbyl groups may be substituted or unsubstituted, and are exemplified above with regard to the appropriate descriptions of hydrocarbyl groups for R″ and R¹. It will be appreciated, however, that oligomers of such alpha olefins may also be utilized in the preparation of the poly-alpha-olefin backbone. For example, polyethylene (PE) oligomers may be utilized to prepare a polyethylene polymer, which may also be prepared using ethene as the sole monomer. Likewise, polyethylene (PE) and polypropylene (PP) oligomers may be copolymerized to prepare a polyethylene-polypropylene (PE-PP) copolymer, such as a PE-PP block copolymer. Examples of other oligomers that may be used to prepare poly-alpha-olefin backbone of the functionalized polyolefin (B) include polypropylene oligomers, polybutylene oligomers, polyisobutylene oligomers, polyisoprene oligomers, polybutadiene oligomers, as well as combinations thereof, such as polyethylene/polypropylene oligomers and copolymers, polyethylene/polybutylene oligomers and copolymers, poly(ethylene/butylene)-polyisoprene oligomers and copolymers, etc.

In certain embodiments, the functionalized polyolefin (B) comprises a poly-alpha-olefin backbone comprising monomeric units selected from ethylene, propylene, butylene, and 2-methyl-propylene (i.e., isobutylene). In these or other embodiments, the poly-alpha-olefin backbone comprises monomeric units derived (or theoretically derivable) from alpha-olefins exemplified by hexene, heptene, octene, styrene, an acrylate or methacrylate compound (e.g. acrylic acid, methacrylic acid, acrylonitrile, methacrylonitrile, an acrylic or methacrylic ester such as a C₁-C₁₂ alkyl ester of acrylic or methacrylic acid, etc.), dienes such as butadiene, etc., or combinations thereof. Accordingly, it will be appreciated that the functionalized polyolefin (B) may comprise, alternatively may be, a homopolymer (i.e., having but one type of monomeric unit, or prepared from but one monomer or oligomers of but one monomer) or an interpolymer (i.e., having at least two different monomeric subunits, typically prepared from at least two monomers or oligomers comprising two or more monomeric subunits). It will be understood that the term “interpolymer” encompasses copolymers and terpolymers, i.e., polymers comprising two, or three, different monomeric units, respectively, as well as polymers prepared from four, five, six, or more monomers.

In particular embodiments, the functionalized polyolefin (B) comprises a functionalized polyethylene, polypropylene, or polyethylene-alpha olefin copolymer. In some such embodiments, the polyethylene-alpha olefin copolymer is selected from copolymers and terpolymers comprising polyethylene and at least one of polypropylene and polybutylene. Various forms of such polyolefins may also be utilized. For example, polyethylenes may be high density (HDPE, ρ≥0.941 g/cm³), medium density (MDPE, ρ=0.926-0.940 g/cm³), low density, (LDPE, ρ=0.910-0.940 g/cm³) or ultra-low density (ULDPE, ρ≤0.880 g/cm³), and variations thereof, such as linear-low density polyethylene (LLDPE, ρ=0.915-0.925 g/cm³). While such polyethylenes are distinguished from one another by density, one of skill in the art will appreciate that various other physical characteristics of such variants differ as well, and may be selected to impart particular properties on the silicone-polyolefin composition, as well as the curable composition and cured products that may be prepared therefrom.

As introduced above, the functionalized polyolefin (B) comprises an average of at least one, alternatively at least two functional groups Y per molecule. For purposes of illustration, the functionalized polyolefin (B) may be represented by the general formula L(−Y)_{I}, where L is the polyolefin backbone, each Y is a functional group as introduced above, and subscript I≥1. It will be appreciated that each functional group Y may be independently selected in each moiety indicated by subscript I, which is at least one, alternatively at least two, but may theoretically be much larger, as will be understood in view of the description of the degree of substitution of the functionalized polyolefin (B. Moreover, the location of each functional group Y along the polyolefin backbone L is not particularly limited, such that any functional group Y may represent a terminal or pendant group.

In some embodiments, the functionalized polyolefin (B) comprises the following general unit formula:

R⁴[CH₂C(R³)(Y)]_{O}[CH₂CH(R³)]ₚR⁴
where each Y is an independently selected functional group as introduced above, each R³ is independently selected from H and substituted and unsubstituted hydrocarbyl groups, each R⁴ is an independently selected terminal group, and subscripts o and p are each mole fractions such that o+p=1, with the provisos that 0<o<1, 0<p<1, the functionalized polyolefin (B) comprises at least one, alternatively at least two functional groups Y, and the moieties indicated by subscripts o and p may be in any order in the functionalized polyolefin (B).

With reference to the general unit formula of the functionalized polyolefin (B) above, one of skill in the art will appreciate that the group R³ is generally selected or otherwise controlled based on the particular alpha-olefin monomers used to prepare the functionalized polyolefin (B), or at least the backbone thereof. For example, where the functionalized polyolefin (B) is a functionalized polypropylene, R³ is methyl in each moiety indicated by subscript k. In such instances, the nature of R³ in the moieties indicated by subscript j will depend on how the functionalized polyolefin (B) was prepared. In particular, where such a functionalized polyethylene is a copolymer prepared from polypropylene and an alpha olefin comprising group Y, R³ will be H in each moiety indicated by subscript o (as opposed to the methyl groups R³ in the moieties indicated by subscript p). On the other hand, where such a functionalized polypropylene is a polypropylene homopolymer grafted with functional groups Y (e.g. via radial mediated grafting), R³ will typically be a methyl group throughout the functionalized polyolefin (B). As such, it will be appreciated that any R³ may be selected such that any one moiety indicated by subscript p may reflect a polymerization product of any of the alpha-olefin monomers described herein or, alternatively, a grafting-functionalization onto a polymer prepared from such alpha-olefins.

In view of the above, it will be appreciated that each R³ may be the same as or different from any other R³ of the functionalized polyolefin (B). In certain embodiments, each R³ is the same as each other R³ of the functionalized polyolefin (B). For example, in some such embodiments, each R³ is methyl. In other embodiments, at least one R³ is different from at least one other R³ of the functionalized polyolefin (B). For example, in certain embodiments, R³ is predominantly hydrogen throughout the functionalized polyolefin (B) (i.e., from ethene monomer), with a minor proportion of R³ being selected from alkyl groups (i.e., from propene or higher-order alpha-olefin monomer).

As introduced above, each R⁴ is an independently selected terminal group. More specifically, each R⁴ generally represents a terminally reacted monomer from the polymerization of the functionalized polyolefin (B), the byproduct of polymerization (i.e., from a radial initiation, propagation, and/or termination step, etc.), or simply a hydrogen atom. One of skill in the art will appreciate that the R⁴ is thus not particularly limited, will generally be selected by virtue of the route by which the functionalized polyolefin (B), and is typically present in the functionalized polyolefin (B) in such minor amounts as to not substantively impact the average unit formula indicated by subscripts o and p. As such, it is to be understood that R⁴ generally represents an unreactive group with regard to the compositions and methods provided herein.

As introduced above, the functionalized polyolefin (B) comprises at least one, alternatively at least two functional groups per molecule, which are represented by moiety Y in the general unit formula of the functionalized polyolefin (B) above. In general, the functional groups Y are selected based on the functional group X of the polysiloxane (A), such that the functionalized polyolefin (B) is reactive with the polysiloxane (A) in a coupling reaction involving functional group X and functional group Y. More specifically, as introduced above, the functional groups Y of the functionalized polyolefin (B) is reactable with the functional group X of the polysiloxane (A) to form a bond therebetween. In other words, one functional group Y and one functional group X are capable of reacting together (i.e., via additive coupling/cross-linking reaction), to covalently bond together the functionalized polyolefin (B) and the polysiloxane (A).

Accordingly, each functional group Y comprises a functional group that may participate in the coupling/cross-linking reaction described above, such as a functional group reactive via substitution reaction, addition reaction, coupling reaction, or combinations thereof, as well as any of the specific variants described above with respect to the functional groups X. Specific examples of such reactions include nucleophilic substitutions, ring-opening additions, alkoxylations and/or transalkoxylations, hydrosilylations, olefin metatheses, condensations, radical couplings and/or polymerizations, and the like, as well as combinations thereof.

Accordingly, functional group Y may comprise, or be, a functional group that is hydrosilylatable, condensable, displaceable, nucleophilic, or otherwise reactable (e.g. graftable, linkable, etc.) with the functional group X, or various combinations thereof. As such, functional group Y may comprise, or be, a functional group that is hydrosilylatable (e.g. a silicon-bonded hydrogen atom, an olefinically (i.e., ethylenically) unsaturated group, such as an alkenyl group, alkynyl group, etc.), condensable (e.g. a hydroxyl group, a carboxyl group, a carbinol group, an alkoxysilyl group, a silanol group, an amide group, an anhydride group, etc., or a group that may be hydrolyzable and subsequently condensable), displaceable (e.g. a “leaving group” as understood in the art, such as a halogen atom, or other group stable in an ionic form once displaced, or a functional group comprising such a leaving group, such as esters, anhydrides, amides, epoxides, etc.), nucleophilic (e.g. a heteroatom with lone pairs, an anionic or anionizable group, etc., such as a hydroxyl group (e.g. of a carbinol), an amine group, a thiol group, a silanol group, a carboxylic acid group, group, etc.), electrophilic (e.g. isocyanates, epoxides, etc.), or various combinations thereof.

In some embodiments, each functional group Y is a hydrosilylatable group. Examples of such hydrosilylatable groups include the olefinically-unsaturated groups (e.g. ethylenically unsaturated groups) described above with respect to the hydrosilylatable groups suitable for functional group X. In specific embodiments, each functional group Y comprises, alternatively is, a vinyl-substituted organosilicon group (e.g. comprises a vinylsilyl group).

In embodiments where the functional group Y comprises one of the ethylenically unsaturated groups above, it will be appreciated that the functional group Y may also comprise a divalent linking group between the ethylenically unsaturated group and a carbon atom of the polyolefin backbone of the functionalized polyolefin (B). In certain embodiments, each functional group Y comprises, alternatively is, a methacryloyl group, methacryloxy group, or a methacrylate group.

Other examples of hydrosilylatable groups suitable for functional group Y include hydridosilyl groups. Examples of such hydridosilyl groups may be generally represented by the subformula -[D³]_{q}—Si(R⁵)₂H, where D³ is a divalent linking group, subscript q is 0 or 1, and each R⁵ is independently H or a hydrocarbyl group. Such moieties may be selected, or otherwise provided, based on a particular alpha-olefin-functional organosilicon compound polymerized in the preparation of the functionalized polyolefin (B). For example, in some embodiments, the functionalized polyolefin (B) comprises a copolymer of ethylene and 7-octenyldimethylsilane, such that, with regard to the preceding general unit formula of the functionalized polyolefin (B) and subformula of the functional group Y, each R³ is H, each subscript q is 1, each linking group D³ is —(CH₂)₆—, and each R⁵ is methyl. In specific embodiments, the functionalized polyolefin (B) comprises the polymerization reaction product of ethylene, an alkenyl-functional silane compound, and optionally one or more additional alpha-olefins (e.g. propene, butene, etc.). In such embodiments, examples of suitable alkenyl-functional silane compounds include 7-octentyldimethylsilane (ODMS), 5-hexenyldimethylsilane (HDMS), allyldimethylsilane (ADMS), and the like, as well as combinations thereof. It will be appreciated that such alkenyl-functional silane compounds may also be grafted onto a polyolefin polymer to prepare the functionalized polyolefin (B). The particular method used to prepare the functionalized polyolefin (B) is not particularly limited, and numerous examples of such methods are known in the art.

In addition to the preceding examples, one of skill in the art will appreciate that other alpha-olefin-functional organosilicon compounds may likewise be used to prepare the functionalized polyolefin (B) to give hydridosilyl groups suitable for functional group Y. More specifically, such organosilicon compounds may be represented by the formula H₂C═C(H)-[D³]_{q}—Si(R⁵)₂H, where each R⁵, D³, and subscript q are as defined above. In some instances, divalent linking group D³ may be silyl or siloxy group.

In some embodiments, each functional group Y is a condensable group, i.e., capable of participating in a condensation reaction. In specific embodiments, each functional group Y comprises condensable group selected from anhydride groups, amine groups, silanol groups, carbinol groups, and alkoxysilyl groups.

Examples of suitable anhydrides and amines for functional group Y generally include those described above with respect to condensable groups suitable for functional group X. However, in view of the preceding examples and descriptions of the functionalized polyolefin (B), one of skill in the art will appreciate that anhydrides available from anhydride-functional compounds with olefinic unsaturation will be particularly suitable for use in some embodiments, such as where the anhydride-functional compound can be readily copolymerized with an alpha-olefin monomer (e.g. ethene), or grafted onto an alpha-olefin homopolymer (e.g. via radical grafting, metathesis, etc.).

Examples of suitable amines for functional group Y generally include primary amino-substituted derivatives of the hydrocarbyl groups described above, as the aminoalkyl groups described above with respect to the functional group X.

In some embodiments, at least one, alternatively at least two, alternatively functional group Y comprises, alternatively is, a silanol group. In certain embodiments, at least one functional group Y comprises, alternatively is, a moiety of formula -D-SiR¹_{3-c}(OH)_{c}, where each D, R¹, and subscript c is independently selected and defined above. In certain embodiments, D is an oxygen atom. In other embodiments, D is a divalent hydrocarbon group having from 2 to 18, alternatively from 2 to 16, alternatively from 2 to 14, alternatively from 2 to 16, alternatively from 2 to 12, alternatively from 2 to 10, alternatively from 2 to 8, alternatively from 2 to 6, alternatively from 2 to 4, carbon atoms.

In some embodiments, at least one, alternatively at least two, alternatively each functional group Y comprises, alternatively is, a carbinol group. The carbinol functional groups can be the same as or different from one another.

In certain embodiments, the carbinol functional groups independently include a moiety having the general formula -D¹-O_{d}—(CₑH₂ₑO)_{f}—H, where D¹ and subscripts d, e, and f are independently selected and defined above. For example, in some embodiments, subscript f is at least 1, such that at least one of the carbinol functional groups includes a moiety having the general formula:

-D¹-O_{d}—[C₂H₄O]_{g}[C₃H₆O]ₕ[C₄H₈O]ᵢ—H;
where D¹ and subscripts d, g, h, and i are independently selected and defined above.

In another embodiment, subscript f is 0 and subscript d is 1 such that at least one of the carbinol functional groups includes a moiety having the general formula: -D¹-OH, where D¹ is described above. In these embodiments, the carbinol functional groups having this general formula are not polyether groups or moieties.

D¹ may be a covalent bond when functional group Y is bonded directly to a carbon atom in the functionalized polyolefin (B).

In some embodiments, at least one, alternatively at least two, alternatively each functional group Y comprises, alternatively is, an alkoxysilyl group.

In embodiments where at least one functional group Y is an alkoxysilyl group, each alkoxysilyl group may independently comprise or be a monoalkoxysilyl group, dialkoxysilyl group, or trialkoxysilyl group, respectively. In particular embodiments, the alkoxysilyl group comprises, alternatively is, a monoalkoxysilyl group. In other embodiments, the alkoxy group comprise, alternatively is, a dialkoxysilyl group. In yet other embodiments, the alkoxysilyl group comprises, alternatively is, a trialkoxysilyl group.

In certain embodiments, at least one functional group Y comprises, alternatively is, a moiety of formula -D²-SiR¹₃₋ⱼ(OR⁶)ⱼ, where each D², R¹, R⁶, and subscript q are independently selected and defined above. Typically, each R⁶ is an independently selected alkyl group having from 1 to 10, alternatively from 1 to 8, alternatively from 1 to 6, alternatively from 1 to 4, alternatively 1 to 3, alternatively 1 or 2, alternatively 1, carbon atoms.

Specific examples of suitable alkoxysilyl groups include those comprising trimethoxysilyl groups, triethoxysilyl groups, dimethoxyethoxysilyl groups, dimethoxymethyl groups, diethoxymethyl groups, methoxyethoxymethyl groups, dimethylmethoxy groups, dimethylethoxy groups, etc.

In some embodiments, at least one, alternatively at least two, alternatively each functional group Y comprises, alternatively is, an epoxy group. Examples of suitable epoxy groups include a 3-glycidoxypropyl group, a 4-glycidoxybutyl group, or similar glycidoxyalkyl (i.e., glycidyloxyalkyl) groups; a 2-(3,4-epoxycyclohexyl)ethyl group, a 3-(3,4-epoxycyclohexyl)propyl group, or similar epoxycyclohexylalkyl groups; a 4-oxiranylbutyl group, and an 8-oxiranyloctyl group. Such epoxy groups may be bonded directly to the functionalized polyolefin (B). Alternatively, a divalent hydrocarbon group may be present in the functional group Y between the epoxide group and the atom to which the functional group Y is bonded. In some of these embodiments, the divalent hydrocarbon group comprises, alternatively is, an alkylene group having the general formula —(CH₂)ₖ—, where subscript k is as defined above. In other embodiments, the divalent hydrocarbon group comprises from 2 to 10 carbon atoms and includes at least one ether moiety, i.e., at least one oxygen heteroatom.

With further reference to the general unit formula of the functionalized polyolefin (B), as introduced above subscripts o and p are each mole fractions such that o+p=1. In general, 0<0<1 and 0<p<1, such that the functionalized polyolefin (B) may comprise at least one functional group Y, and theoretically many of such groups, but is not fully-substituted in terms of each olefin subunit present in the functionalized polyolefin (B) (e.g. as indicated by subscript p>0. In some embodiments, the moieties indicated by subscript o comprise from 0.01 to 5%, alternatively from 0.01 to 2.5% of the total number of olefin subunits in the functionalized polyolefin (B) (e.g. o+p). In these of other embodiments, the moieties indicated by subscript o may comprise from 0.05 to 10 wt. % of the functionalized polyolefin (B) (e.g. by total weight).

The particular properties and physical characteristics of the functionalized polyolefin (B) may be varied. In some embodiments, the functionalized polyolefin (B) comprises a number average molecular weight of from 10 to 100 kDa, such as from 10 to 90, alternatively from 15 to 90, alternatively from 15 to 80, alternatively from 20 to 80, alternatively from 20 to 70, alternatively from 20 to 65 kDa. In these or other embodiments, the functionalized polyolefin (B) comprises a molecular weight distribution, as represented by the polydispersity index (PDI) (e.g. as determined by gel permeation chromatography (GPC)), of from 1 to 12, such as from 1 to 10. In some embodiments, the functionalized polyolefin (B) exhibits a PDI of from 1 to 5, such as from 1 to 4, alternatively from 1.5 to 3.5, from 1.75 to 3.25, alternatively from 2 to 3. In some embodiments, the functionalized polyolefin (B) exhibits a PDI of from 3 to 6, such as from 3.5 to 5.5, alternatively from 4 to 5.

As introduced above, the silicone-polyolefin composition comprises the curable silicone elastomer component (C). As will be understood by those of skill in the art in view of the description and examples herein, the curable silicone elastomer component (C) typically represents the predominant component of the silicone-polyolefin composition, and is adapted for facilitating the formation of curable and cured compositions therefrom. In general, the curable silicone elastomer component (C) comprises a functional silicone, i.e., a reaction-curable silicone, optionally with additional components (e.g. filler, etc., as described below). In this fashion, it will be understood by those of skill in the art that component (C) may be referred to or otherwise described as a “silicone elastomer base,” a “curable silicone base,” a “curable silicone elastomer base,” and/or other such terms known in the art. As such, it will be appreciated that component (C) is generally capable of being cured to prepare a silicone elastomer, and does not typically itself comprise an elastomer until such curing.

Silicones suitable for use in, or as, the curable silicone elastomer component (C) (e.g. as the functional/reaction-curable silicone) may be described in terms of the [M], [D], [T], and/or [Q] units/siloxy groups of the polymers therein. More specifically, the curable silicone elastomer component (C) typically comprises a curable organosiloxane, which may comprise any number and/or combination of M, D, T and/or Q siloxy units combined in various manners to form cyclic, linear, branched and/or resinous structures as described above. Typically, however, the organosiloxane of component (C) is substantially free from, alternatively is free from, resinous segments. In these or other embodiments, the organosiloxane of component (C) is substantially free from, alternatively is free from, [T] and/or [Q] units.

Specific compounds and compositions suitable for use in, or as, organosiloxane (C) are commercially available, and may be selected based on particular properties thereof. For example, in some embodiments, component (C) comprises, alternatively is, a silicone high-consistency rubber (HCR) base. In specific embodiments, component (C) may be characterized as a 40 durometer silicone rubber base.

In specific embodiments, the curable organosiloxane of component (C) comprises, alternatively is, a polydiorganosiloxane gum, i.e., an organopolysiloxane comprising predominately D siloxy units and having a molecular weight sufficiently high enough to exhibit a dynamic viscosity of from 1 to 1000 mPa·s (at 25° C.). In some embodiments, the polydiorganosiloxane gum may exhibit a Williams plasticity number of at least 40 (e.g. as determined by the American Society for Testing and Materials (ASTM) test method 926), such as a plasticity number of from 40 to 200, although other or narrower ranges (e.g. 50 to 150) may be selected based on a particular desired use of the silicone-polyolefin composition. In some embodiments, the polydiorganosiloxane gum comprises a number average molecular weight of at least 600,000 Daltons, such as a molecular weight of 1,000,000 or more, alternatively of, 2,000,000 or more, Daltons.

The curable organosiloxane of component (C) is typically reaction-curable. In such embodiments, the organosiloxane typically comprises an average of at least two functional groups per molecule, where the functional groups are reactive with one or more other components during a curing process, as described in further detail below. Typically, the particular functionality of such reaction-curable organosiloxanes is selected based on the other components of the silicone-polyolefin composition and/or compositions to be prepared therewith. For example, in some embodiments, the reaction-curable organosiloxane comprises functional groups complementary to and reactive with the functional groups X of the polysiloxane (A), e.g. to form a bond therebetween (i.e., via additive cross-linking reaction). In specific embodiments, component (C) comprises a reaction-curable organosiloxane comprising hydrosilylatable or a condensable functional groups. In some such embodiments, component (C) comprises olefinic unsaturation, e.g. in the form of ethylenically unsaturated groups that may be exploited in a hydrosilylation reaction. In other embodiments, the reaction-curable organosiloxane of component (C) comprises cross-linkable functionality different than that of functional groups X and Y of components (A) and (B), respectively. For example, in some embodiments, functional groups X and Y are addition-reactable, and component (C) comprises a radically-curable organosiloxane.

In some embodiments, component (C) comprises a reaction-curable organosiloxane comprising one or more functional groups reactive with a filler, e.g. directly or at a surface treatment/modification thereof. For example, in some embodiments, component (C) further comprises a silica (e.g. a treated, fumed silica), which may be mutually selected with the reaction-curable organosiloxane to influence the reaction-curable nature of the silicone-polyolefin composition and/or curable compositions formed therewith. The curable silicone elastomer component (C) may comprise other components in addition to or, with regard to certain components like the silica, in place of those described above. For example, the base silicone elastomer (C) may comprise one or more fillers or additives, such as those described herein.

In some embodiments, the organosiloxane of component (C) may be further defined as a fluorosilicone base. For example, in specific embodiments, the curable organosiloxane of component (C) may comprise a fluoroalkyl silicone, such as a trifluoromethyl silicone.

The amount of components (A), (B), and (C) in the silicone-polyolefin composition may vary, as will be best understood in view of the additional description below.

Typically, the polysiloxane (A) is present in the silicone-polyolefin composition in an amount of from 1 to 30 wt. %, such as from 1 to 20, alternatively from 1 to 15, alternatively from 1 to 10 wt. %, based on the total weight of the silicone-polyolefin composition. The functionalized polyolefin (B) is typically present in the silicone-polyolefin composition in an amount of from 1 to 50 wt. %, alternatively from 1 to 30 wt. %, based on the total weight of the silicone-polyolefin composition. The component (C) is typically present in the silicone-polyolefin composition an amount of from 20 to 98 wt. %, alternatively from 60 to 98 wt. %, based on the total weight of the silicone-polyolefin composition.

In some embodiments, the amount of component (A), (B), and/or (C) corresponds to the ranges above, where the wt. % is determined on a basis of the combined weight of components (A), (B), and (C) (i.e., rather than the silicone-polyolefin composition as a whole, should additional components be present.

With regard to the preceding embodiments and component amounts, it is to be understood that the balance of the silicone-polyolefin composition, if any, may comprise one or more additional components of the silicone-polyolefin composition. For example, as will be better understood in view of the additional description and methods described herein, the silicone-polyolefin composition may comprise a catalyst, a solvent or carrier vehicle, or a reaction promotor. In some embodiments, however, the silicone-polyolefin composition is free from, alternatively substantially free from, a reaction catalyst or promotor. In these or other embodiments, the silicone-polyolefin composition comprises less than 1 wt. % solvent, based on the total weight of the silicone-polyolefin composition. In other embodiments, the silicone-polyolefin composition is substantially free from, alternatively is free from, solvents or carrier vehicles.

It will also be appreciated that amounts outside of the ranges and ratios above may also be utilized. However, as will also be better understood in view of the additional description and methods described herein, decreased loadings of the polysiloxane (A) and/or increased loadings of the functionalized polyolefin (B) may result in macrophase separation due to poor compatibilization.

In some embodiments, the silicone-polyolefin composition comprises a (D) catalyst adapted to facilitate a coupling reaction between the functional groups X of the polysiloxane (A) and functional groups Y of the functionalized polyolefin (B).

The use of the catalyst (D), as well as the particular type or specific compound(s) selected for use in or as the catalyst (D), will be selected by those of skill in the art based on the particular polysiloxane (A) and functionalized polyolefin (B) selected. More specifically, the catalyst (D) is not particularly limited, but is instead selected to catalyze coupling of components (A) and (B), and may thus comprise or be any compound suitable for facilitating the reaction of the polysiloxane (A) and the functionalized polyolefin (B) (e.g. via reaction of/including functional groups X and functional groups Y), as will be understood by one of skill in the art in view of the description herein. For example, in certain embodiments, the catalyst (D) is selected from those facilitating reactions including hydrosilylation, condensation, displacement, ring-opening, nucleophilic substitution, and the like, as well as combinations of such reactions. It is to be appreciated that the catalyst (D) may itself comprise more than one type of catalyst and/or the reaction may utilize more than one type of catalyst (D), such as two, three, or more different catalysts (D).

In specific embodiments, the catalyst (D) comprises, alternatively is, a hydrosilylation catalyst. In such embodiments, functional groups X and functional groups Y are complementary coupleable hydrosilylatable groups.

Hydrosilylation catalysts suitable for use in the silicone-polyolefin composition are not particularly limited and may be any known catalyst for catalyzing hydrosilylation reactions. Combinations of different hydrosilylation catalysts may also be utilized.

In certain embodiments, the hydrosilylation catalyst comprises a Group VIII to Group XI transition metal. Group VIII to Group XI transition metals refer to the modern IUPAC nomenclature. Group VIII transition metals are iron (Fe), ruthenium (Ru), osmium (Os), and hassium (Hs); Group IX transition metals are cobalt (Co), rhodium (Rh), and iridium (Ir); Group X transition metals are nickel (Ni), palladium (Pd), and platinum (Pt); and Group XI transition metals are copper (Cu), silver (Ag), and gold (Au). Additional examples of catalysts suitable for the hydrosilylation catalyst include rhenium (Re), molybdenum (Mo), Group IV transition metals (i.e., titanium (Ti), zirconium (Zr), and/or hafnium (Hf)), lanthanides, actinides, and Group I and II metal complexes (e.g. those comprising calcium (Ca), potassium (K), strontium (Sr), etc.). Combinations, complexes (e.g. organometallic complexes), and other forms of such metals may also be utilized as the hydrosilylation catalyst.

The hydrosilylation catalyst may be in any suitable form. For example, the hydrosilylation catalyst may be a solid, or instead by may be disposed in or on a solid carrier. Examples of solid catalysts typically include platinum-based catalysts, palladium-based catalysts, and similar noble metal-based catalysts, and also nickel-based catalysts. Specific examples thereof include elemental nickel, palladium, platinum, rhodium, cobalt, and similar metals, and also elemental mixtures/combinations such as platinum-palladium, nickel-copper-chromium, nickel-copper-zinc, nickel-tungsten, nickel-molybdenum, and the like, as well as Cu—Cr, Cu—Zn, Cu—Si, Cu—Fe—Al, Cu—Zn—Ti, and similar copper-containing catalysts. Examples of carriers include activated carbons, silicas, silica aluminas, aluminas, zeolites and other inorganic powders/particles (e.g. sodium sulphate), and the like. The hydrosilylation catalyst may also be disposed in a vehicle, e.g. a solvent which solubilizes the hydrosilylation catalyst, alternatively a vehicle which merely carries, but does not solubilize, the hydrosilylation catalyst. Such vehicles are known in the art.

In specific embodiments, the hydrosilylation catalyst comprises platinum. In these embodiments, the hydrosilylation catalyst is exemplified by platinum black, chloroplatinic acids (e.g. chloroplatinic acid hexahydrate, reaction products of chloroplatinic acid and a monohydric alcohol, or aliphatically-unsaturated organosilicon compound such as divinyltetramethyldisiloxane, etc.), platinum bis(ethylacetoacetate), platinum bis(acetylacetonate), platinum chloride, complexes of any such compounds with olefins or organopolysiloxanes, and microencapsulated platinum compounds (e.g. matrix or core-shell type). For example, suitable complexes of platinum with organopolysiloxanes, such as 1,3-diethenyl-1,1,3,3-tetramethyldisiloxane complexes with platinum, may be used directly or, alternatively, in microencapsulated form (e.g. in a resin matrix).

The hydrosilylation catalyst may be a photoactivatable hydrosilylation catalyst, which may initiate curing via irradiation (e.g. upon exposure to radiation having a wavelength of from 150 to 800 nm) and/or heat.

Specific examples of photoactivatable hydrosilylation-reaction catalysts suitable for the catalyst (D) include platinum(II) β-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene·Pt[p-ON—C₆H₄NNNOC₆H₁₁]₂, 1,5-cyclooctadiene·Pt[p-CH₃O—C₆H₄NNNOCH₃]₂, [(C₆H₅)₃P]₃Rh[p-ON—C₆H₄NNNOC₆H₁₁], and Pd[p-CH₃(CH₂)ₓ—C₆H₄NNNOCH₃]₂, where x is 1, 3, 5, 11, or 17; (η-diolefin)(σ-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. In specific embodiments, the photoactivatable hydrosilylation-reaction catalyst of the catalyst (D) is a Pt(II) β-diketonate complex, such as platinum(II) bis(2,4-pentanedioate).

It will be appreciated that the compounds described above with regard to the catalyst (D) above, i.e., when comprising or being the hydrosilylation catalyst, may generally promote rapid reaction (i.e., coupling, cross-linking, etc.) of components (A) and (B) of the silicone-polyolefin composition (i.e., when reactable via hydrosilylation, as described above), even at room temperature. As such, in certain embodiments, the silicone-polyolefin composition further comprises a reaction inhibitor, which may be further defined as a cross-linking reaction inhibitor, a hydrosilylation reaction inhibitor, or a stabilizer. Suitable inhibitors are known in the art, and generally include compounds that stop catalysis, yet are volatile or readily decomposed by heat or light (e.g. UV). Examples of such inhibitors typically include relatively low-boiling alkyne- and alkene-based compounds with electron-withdrawing groups, which complex with catalytic metals and thereby block activity thereof until heat is applied. General examples of inhibitors include acetylenic alcohols having boiling points of less than 250° C. (e.g. 2-methyl-3-butyn-2-ol, 1-ethynylcyclohexanol (ETCH)), as well as various fumarates, maleates (e.g. diallyl maleate), small vinyl-functional siloxanes (e.g. tetravinyl-tetramethyltetrasiloxane), ethynylalkenes (e.g. 3-methyl-3-penten-1-yne, 3-methyl-3-hexen-1-yne, 3,5-dimethyl-3-hexen-1-yne, 3-ethyl-3-buten-1-yne, 3-phenyl-3-buten-1-yne, etc.), dialkyl esters of acetylenedicarboxylic acids (e.g. dimethyl acetylenedicarboxylate (DMAD)), and the like, as well as various derivatives thereof. One of skill in the art will selected such an inhibitor for use in or as the reaction inhibitor in view of the particular other components utilized for the silicone-polyolefin composition, as well as the intended use thereof, including the uses and processes disclosed herein. For example, it is well understood that particular hydrosilylation reaction inhibitors/stabilizers exhibit different compatibilities and operating windows (e.g. in terms of light and/or heat sensitivity, require loading amounts, etc.), such that a person of skill in the art will readily select an appropriate inhibitor for use as the reaction inhibitor, if needed, based on the description of the compositions and methods provided herein.

In specific embodiments, the catalyst (D) comprises, alternatively is, a condensation catalyst. In such embodiments, functional groups X and functional groups Y are complementary condensable groups (e.g. amine (X)+anhydride (Y)).

Condensation catalysts suitable for use in the silicone-polyolefin composition may be any known compound (or combination) compatible with components (A) and (B) and capable of catalyzing or otherwise facilitating a condensation reaction of functional groups X and Y. Combinations of different hydrosilylation catalysts may also be utilized.

Examples of condensation catalysts generally inorganic and organic bases and acids (i.e., an acid-type or base-type catalyst), which may comprise metal atoms or, alternatively, may be substantially free from, alternatively free from metal atoms. Examples of such catalysts generally include mineral acids and bases (e.g. H₂SO₄, LiOH, NaOH, KOH, CsOH, etc.), organic bases and amines (e.g. tetramethylammonium hydroxide ((CH₃)₄NOH), 1,8-diazabicyclo [5.4.0]undec-7-ene (DBU)), organic and inorganic acids (e.g. carboxylic acids, sulfamic acids, etc.), and particular metal complexes such as titanium alkoxides (e.g. Ti(OiPr)₂(acac)₂), and the like, as well as derivatives, modifications, and combinations thereof. Such condensation catalysts are well known in the art and commercially available.

When utilized, particular condensation catalysts will be selected by those of skill in the art in view of the particular components and conditions utilized in the silicone-polyolefin composition, and processes involving the same. Particular limitations will be understood in view of the description below. For example, in some embodiments, residual amounts of catalyst may be carried forward from the silicone-polyolefin composition to other compositions and/or processes that may be incompatible with certain types of condensation catalysts. As such, in certain embodiments, the catalyst (D), optionally the silicone-polyolefin composition as a whole, is substantially free from, alternatively free from, one or more metal-based condensation catalysts, strong acids and bases, oxidizing compounds, and the like.

It is to be appreciated that other catalysts may also be utilized, regardless of falling under one of the general descriptions herein. For example, in will be understood that certain coupling reactions described herein may be facilitated by various Lewis acid catalysts, such as those based on boron, aluminum, iron, tin, and titanium, such as tri- or tetravalent halides and alkoxides thereof. Likewise, in certain embodiments, the catalyst (D) comprises, alternatively is, a Piers-Rubinsztajn-type catalysts (e.g. tris(pentafluorophenyl)borane), which may be utilized to facilitate the coupling between one of the hydridosilyl groups (e.g. functional group X) and an alkoxy- or hydroxy-silyl groups (e.g. functional groups Y) described herein.

The catalyst (D) may be utilized in any amount, which will be selected by one of skill in the art, e.g. dependent upon the particular catalyst (D) selected (e.g. the concentration/amount of active components thereof, the type of catalyst being utilized, the type of coupling reaction being performed, etc.), the scale being utilized (e.g. total amounts of components (A) and (B), relative amounts of functional groups X and functional groups Y, etc.), etc. As will be best understood in view of the description below, the molar ratio of the catalyst (D) to components (A) and/or (B) utilized in the reaction may influence the rate and/or amount of coupling/crosslinking, when desired. Thus, the amount of the catalyst (D) as compared to components (A) and/or (B), as well as the molar ratios therebetween, may vary. Typically, these relative amounts and the molar ratio are selected to maximize the reaction of components (A) and (B) (e.g. via functional groups X an Y) while minimizing the loading of the catalyst (D) (e.g. for increased economic efficiency of the reaction, increased ease of purification of the reaction product formed, etc.).

For example, it will be appreciated that, beyond a minimum threshold value, decreasing catalyst loadings may result in poor reactivity, and thus may not be able to achieve the properties and effects demonstrated and described herein. With regard to the present embodiments, such a minimum threshold is generally applicable to the hydrosilylation-mediated coupling reaction of components (A) and (B) described herein. As such, in typical embodiments where the functional groups X and functional groups Y are complementary coupleable hydrosilylatable groups, the silicone-polyolefin composition comprises the hydrosilylation catalyst of catalyst (D) in an amount of from 1 to 100 ppm, alternatively from 5 to 100 ppm. However, it will also be appreciated that loadings outside these ranges may be utilized to realize the benefits described herein, and one of skill in the art will be able to determine proper catalyst loadings (e.g. based on reactivity rates, compatibilization of components (A) and (B), etc.) in view of the description and examples herein. For example, such minimum threshold amounts of catalyst (D) may not be needed in other embodiments, such as where the epoxy-amine coupling reaction of components (A) and (B) is utilized.

Likewise, in yet other embodiments, the silicone-polyolefin composition is substantially free, alternatively is free from a reaction catalyst or promotor, including those described above with regard to the catalyst (D). As will be understood in view of the additional description herein, certain features of the silicone-polyolefin composition and related methods and compositions may be realized and/or achieved without the use of a catalyst or promotor. For example, in specific embodiments, the functional groups X and functional groups Y are complementary condensable groups (e.g. amine (X)+anhydride (Y)), and the silicone-polyolefin composition is substantially free, alternatively is free from a condensation catalyst or promotor. Other cross-linking chemistries may also be used absent a discreet catalyst loading, such as the amine-methacrylate, silanol-alkoxysilane, and carbinol-anhydride couplings provided herein.

In certain embodiments, the catalyst (D) is utilized in the silicone-polyolefin composition in an amount of from 0.000001 to 5 wt. %, based on the total amount of component (A) utilized (i.e., wt./wt.). For example, the catalyst (D) may be used in an amount of from 0.00001 to 5 wt. %, such as from 0.00001 to 4, alternatively from 0.00001 to 3, alternatively from 0.00001 to 2, alternatively from 0.0001 to 2, alternatively from 0.0001 to 1, alternatively from 0.0001 to 0.5, alternatively from 0.001 to 0.5, alternatively of from 0.005 to 0.5, wt. %, based on the total amount of component (A) utilized. Likewise, or alternatively, the catalyst (D) may be utilized in the silicone-polyolefin composition in an amount of from 0.000001 to 5 wt. %, based on the total amount of component (B) utilized (i.e., wt./wt.). For example, the catalyst (D) may be used in an amount of from 0.00001 to 5 wt. %, such as from 0.00001 to 4, alternatively from 0.00001 to 3, alternatively from 0.00001 to 2, alternatively from 0.0001 to 2, alternatively from 0.0001 to 1, alternatively from 0.0001 to 0.5, alternatively from 0.001 to 0.5, alternatively of from 0.005 to 0.5, wt. %, based on the total amount of component (B) utilized.

In some embodiments (e.g. when the type of reaction dictates a stoichiometric loading), the amount of the catalyst (D) utilized may be selected and/or determined on a molar ratio based on one or more components of the silicone-polyolefin composition, as will be understood by those of skill in the art. In such embodiments, the catalyst (D) may be utilized in the silicone-polyolefin composition in an amount of from 0.0001 to 5 mol %, based on the total amount of component (A) and/or component (B) utilized. For example, the catalyst (D) may be used in an amount of from 0.0005 to 5, alternatively of from 0.0005 to 3, alternatively of from 0.0005 to 1, alternatively of from 0.001 to 1 mol %, based on the total amount of component (A) utilized.

The functionalized polyolefin (B) and the curable silicone elastomer component (C) are typically immiscible, or substantially immiscible. As such, as introduced above, a method of preparing a hybrid silicone-polyolefin blend from the silicone-polyolefin composition (the “preparation method”) is also provided, and generally comprises compatibilizing the functionalized polyolefin (B) with the polysiloxane (A) within the silicone-polyolefin composition.

More specifically, the preparation method allows for the preparation of a uniform dispersion of the functionalized polyolefin (B) in component (C) (i.e., as a polyolefin-in-silicone dispersion), which components are based on otherwise non-compatible chemistries (i.e., polysiloxanes and polyolefins). Moreover, the preparation method provides the silicone-polyolefin blend as a uniform composition having small domains (e.g. polyolefin domains) and a useful characteristics supporting application of the silicone-polyolefin blend to curable compositions.

The polysiloxane (A) is capable of compatibilizing the functionalized polyolefin (B), e.g. via additive coupling/cross-linking reaction between the functional groups X and functional groups Y, respectively. As such, the preparation method comprises reacting the polysiloxane (A) and the functionalized polyolefin (B). Typically, components (A) and (B) are reacted in the presence of component (C). As such, it will be understood that the preparation method may be carried out on the silicone-polyolefin composition in a pre-made form, or may include preparing the silicone-polyolefin composition (e.g. by combining the polysiloxane (A), the functionalized polyolefin (B), and component (C), optionally with any of the additional and/or optional components described here, such as the catalyst (D)). In this fashion, the silicone-polyolefin composition may be referred to or characterized as a reactive pre-mix, or a compatibilization mixture, comprising at least components (A), (B), and (C) or the silicone-polyolefin composition.

With regard to the method components, the polysiloxane (A), functionalized polyolefin (B), and the curable silicone elastomer component (C) may each be prepared (i.e., as part of the preparation method) or otherwise obtained, e.g. as prepared reagents/feedstocks. Methods of preparing each of these components (e.g. reactable/cross-linkable polydiorganosiloxanes, functionalized poly-alpha olefin-alkenyl copolymers, reaction-curable polydiorganosiloxane gums, etc.) are known in the art, with suitable precursors and starting materials commercially available from various suppliers.

Components (A), (B), and (C) may be utilized in any amount, bearing in mind the upper limit/ratio of the functionalized polyolefin (B) with regard to compatibilization by the polysiloxane (A) described above. As such, suitable amounts which will be selected by one of skill in the art, e.g. dependent upon the particular components selected, the reaction parameters employed for the compatibilization, the scale of the compatibilization (e.g. total amounts of components (A), (B), and (C) in the silicone-polyolefin composition being utilized, etc.

In general, components ((A), (B), and (C) may independently be utilized in any form, such as neat (i.e., absent solvents, carrier vehicles, diluents, etc.), or disposed in a carrier vehicle, such as a solvent or dispersant, as described in further detail below. However, in certain embodiments, each of (A), (B), and (C) is utilized neat, or otherwise in a form substantially free from, alternatively free from a carrier vehicle. When substantially free from carrier vehicles, components ((A), (B), and (C) will typically be free from (or at substantially free from), water and carrier vehicles/volatiles reactive with any components to participate in the compatibilization, or post-compatibilization reaction, as described below. As such, in some embodiments, the compatibilization, or the preparation method as a whole, is carried out in the absence of carrier vehicles/volatiles that are reactive with the polysiloxane (A) (i.e., at the polysiloxane backbone or the functional groups X), the functionalized polyolefin (B) (e.g. at the functional groups Y, or any one or more other components being utilized to prepare the silicone-polyolefin composition (e.g. the catalyst (D), if present). For example, in certain embodiments, the preparation method may comprise stripping a mixture comprising one or more of the components (A), (B), and (C), and optionally (D) (i.e., the “compatibilization components”) of volatiles, solvents, etc., e.g., prior to combining the same with any one or other components being utilized in the preparation method. Techniques for stripping such siloxanes, polyolefins, and reaction catalysts are generally known in the art, and may include heating, drying, applying reduced pressure/vacuum, azeotroping with solvents, utilizing drying agents such as molecular sieves, etc., and combinations thereof, with care take to not initiate premature reaction with the functional groups X or functional groups Y.

In some embodiments, one or more of the compatibilization components may be combined with a carrier vehicle, e.g. prior to and/or during the compatibilization of component (B). When combined prior to the compatibilization, e.g. as part of the preparation of such component, or to otherwise facilitate providing and/or metering out a component to the compatibilization mixture, the stripping process above may be carried out. When the carrier vehicle is to be present during the compatibilization, it will be appreciated that suitable choices will be limited based on compatible with the components and conditions of the compatibilization process.

With regard to carrier vehicles generally, examples typically include oils (e.g. organic oils and/or a silicone oils), fluids, solvents, etc., and combinations thereof. For example, in some embodiments, one or more of the components of the compatibilization disposed in a carrier fluid prior to being combined with the other components of the compatibilization. In some such embodiments, the carrier fluid comprises, alternatively consists essentially of, a silicone fluid. The silicone fluid is typically a low viscosity and/or volatile siloxane. In some embodiments, the silicone fluid is a low viscosity organopolysiloxane, a volatile methyl siloxane, a volatile ethyl siloxane, a volatile methyl ethyl siloxane, or the like, or combinations thereof. Typically, the silicone fluid has a viscosity at 25° C. in the range of 1 to 1,000 mPa-s. Specific examples of suitable silicone fluids include hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, hexamethyldisiloxane, heptamethyloctyltrisiloxane, hexyltrimethicone, and the like, as well as derivatives, modifications, and combinations thereof. Additional examples of suitable silicone fluids include polyorganosiloxanes with suitable vapor pressures, such as from 5×10⁻⁷ to 1.5×10⁻⁶ m²/s, such as DOWSIL® 200 Fluids and DOWSIL® OS FLUIDS, which are commercially available from Dow Silicones Corporation of Midland, Mich., U.S.A.

In other such embodiments, the carrier fluid comprises, alternatively consists essentially of, an organic fluid, which typically comprises an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.) C₈-C₁₆ branched esters (e.g. isohexyl neopentanoate, isodecyl neopentanoate, etc.), and the like, as well as derivatives, modifications, and combinations thereof. Additional examples of suitable organic fluids include aromatic hydrocarbons and aliphatic hydrocarbons. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, octyl palmitate, and combinations thereof.

In yet other such embodiments, the carrier fluid comprises, alternatively consists essentially of, an organic solvent. Examples of the organic solvents include those comprising a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a glycol ether, such as propylene glycol methyl ether, dipropylene glycol methyl ether, propylene glycol n-butyl ether, propylene glycol n-propyl ether, and ethylene glycol n-butyl ether; a halogenated hydrocarbon, such as dichloromethane, 1,1,1-trichloroethane and methylene chloride; chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof.

As introduced above, and notwithstanding the preceding section, the compatibilization reaction (i.e., the reaction of components (A) and (B) in the presence of component (C)) may be carried out under conditions substantially free from carrier vehicle or solvent. Indeed, as will be appreciated from the examples and additional description herein, certain features of the preparation method enable solventless preparation of the compatibilized blends of the silicone components (e.g. components (A) and (C)) and the functionalized polyolefin (B).

As also introduced above, the compatibilization mixture may comprise components other than components (A), (B). For example, in certain embodiments, the reaction (i.e., the compatibilization) is further defined as the hydrosilylation reaction, where the functional groups (X) and functional groups (Y) are selected from the complementary hydrosilylatable groups (e.g. where each X is the silicon-bonded olefinically-ethylenically unsaturated group, and each Y comprises the hydridosilyl group). In such embodiments, the compatibilization mixture will typically include the hydrosilylation catalyst (D). In other embodiments, however, the compatibilization is further defined as the condensation reaction, where the functional groups (X) and functional groups (Y) are selected from the complementary condensable groups (e.g. where each X is the aminoalkyl group and each Y comprises the anhydride group). In some such embodiments, the compatibilization is free from catalyst (e.g. condensation catalyst (D)).

The components of the silicone-polyolefin composition are typically combined in a vessel or reactor to carry out the compatibilization and disperse component (B) in component (C), and thereby prepare the silicone-polyolefin blend. The compatibilization components may be fed together or separately to the vessel, or may be disposed in the vessel in any order of addition, and in any combination, to prepare the compatibilization mixture (i.e., the silicone-polyolefin composition). Likewise, the compatibilization mixture may be prepared in batch, semi-batch, semi-continuous, or continuous processes, unless otherwise noted herein.

Typically, the silicone-polyolefin blend is prepared via dynamic reaction/crosslinking of the silicone-polyolefin blend i.e., via mixing together the components (A), (B), (C), and optionally (D), as the coupling/crosslinking is carried out. In this sense, the term “dynamic” indicates the silicone-polyolefin composition is subjected to shear forces during the crosslinking/compatibilization step, in contrast to “static crosslinking” whereby a polymer is relatively immobile during such crosslinking.

The compatibilization is typically conducted at an elevated temperature with mixing (e.g. under shear). As such, the vessel or reactor is typically heated, e.g. via a jacket, mantle, exchanger, bath, coils, etc., and equipped with mixing means for blending and/or shearing the compatibilization mixture. In general, the elevated temperature for compatibilization is from 100 to 200° C. In specific embodiments, the elevated temperature is from 100 to 180, alternatively from 100 to 170, alternatively from 100 to 160, alternatively from 100 to 150, alternatively from 110 to 150, alternatively from 110 to 140° C.

With regard to the mixing/shear, the silicone-polyolefin composition is typically homogenized via melt blending or extruding the silicone-polyolefin composition at the elevated temperature to prepare the silicone-polyolefin blend. As such, while other reactors and mixing/blending techniques (e.g. using twin-rotor mixers, ribbon blenders, solution blenders, co-kneaders, screw extruders, static mixers, Banbury-type mixers, etc.) may be utilized, in certain embodiments the reactor/vessel is an extruder or melt blender. However, one of skill in the art will understand that other mixers may also be utilized.

As the compatibilization progresses and the components are mixed and reacted, the functionalized polyolefin (B) is taken into and dispersed uniformly throughout component (C), thereby preparing the silicone-polyolefin blend as a polyolefin-in-silicone dispersion.

As introduced above, the silicone-polyolefin blend comprises the functionalized polyolefin (B) dispersed in a combination of the polysiloxane (A) and the curable silicone elastomer component (C). The silicone-polyolefin blend presents as a thick but spreadable mixture comprising the discontinuous phase composed of the polyolefin (B), uniformly dispersed in the continuous phase composed of component (C) and polysiloxane (A). Said differently, the silicone-polyolefin blend comprises domains of the polyolefin (B) (i.e., “polyolefin domains”) dispersed in the silicone matrix presented by component (C). In certain embodiments, the polyolefin domains are uniformly dispersed through the continuous phase comprising component (C).

A curable composition is also provided herein. In the same nature as the silicone-polyolefin compositions and blend described above, the curable composition does not require a carrier vehicle or solvent under typical circumstances. As such, the curable composition may be solvent-free (i.e., free from, alternatively substantially free from, a carrier vehicle or solvent).

The curable composition comprises the silicone-polyolefin blend and a curing agent, although other components may also be utilized. The curing agent typically comprises, alternatively is, a free radical initiator and/or a photoinitiator.

Examples of suitable free radical initiators typically include benzoyl peroxide, tert-butyl peroxide, dicumyl peroxide, lauroyl peroxide, peracetic acid, cyclohexanone peroxide, cumene hydroperoxide, tert-butyl peroxide, tert-butyl hydroperoxide, 2,2′-azobisisobutyronitril (AIBN), 2,2′-azodi(2-methylbutyronitrile) (AMBN), tert-amyl peroxybenzoate, tert-butyl peracetate, tert-butyl peroxybenzoate, tert-butylperoxy isopropyl carbonate, cumene hydroperoxide, and potassium persulfate. Any amount of the free radical initiator may be used in the curable composition, although only catalytic amounts are typically necessary. For examples, in certain embodiments, the curable composition comprises the free radical initiator in an amount of from 0.01 to 10 wt. %, based on the total weight of the curable composition. In some embodiments, the free radical initiator is employed in an amount of at least 0.15, alternatively at least 0.2 wt. %, while at the same time 10, alternatively 7, alternatively 5, alternatively 3 wt. % or less, preferably 5 wt. % or less and can be 3 wt. % or less, based on the total weight of the curable composition. Amounts outside of these ranges may also be utilized, recognizing that excess free radical initiator may not significantly increase the time or efficiency of the curing process, which is typically complete in less than 30, alternatively less than 20, alternatively less than 15, alternatively less than 15 minutes, while at the same time typically greater than 1, alternatively greater than 5 minutes.

Examples of suitable photoinitiators include onium salts, nitrobenzyl sulfonate esters, diaryliodonium salts of sulfonic acids, triarylsulfonium salts of sulfonic acids, diaryliodonium salts of boronic acids, triarylsulfonium salts of boronic acids, bis-diaryl iodonium salts (such as bis(dodecyl phenyl) iodonium hexafluoroarsenate and bis(dodecylphenyl) iodonium hexafluoroantimonate), dialkylphenyl iodonium hexafluoroantimonate, diaryliodonium salts of sulfonic acids, triarylsulfonium salts of sulfonic acids, diaryliodonium salts of boronic acids, and triarylsulfonium salts of boronic acids.

Examples of suitable diaryioadonium salts of sulfonic acid include diaryliodonium salts of perfluoroalkylsulfonic acids and diaryliodonium salts of aryl sulfonic acids. Examples of suitable diaryliodonium salts of perfluoroalkylsulfonic acids include diaryliodonium salts of perfluorobutanesulfonic acid, diaryliodonium salts of perfluoroethanesulfonic acid, diaryliodonium salts of perfluoro-octanesulfonic acid, and diaryliodonium salts of trifluoromethane sulfonic acid. Examples of suitable diaryliodonium salts of aryl sulfonic acids include diaryliodonium salts of para-toluene sulfonic acid, diaryliodonium salts of dodecylbenzene sulfonic acid, diaryliodonium salts of benzene sulfonic acid, and diaryliodonium salts of 3-nitrobenzene sulfonic acid. Examples of suitable triarylsulfonium salts of sulfonic acid include triarylsulfonium salts of perfluoroalkylsulfonic acids and triarylsulfonium salts of aryl sulfonic acids. Examples of suitable triarylsulfonium salts of perfluoroalkylsulfonic acids include triarylsulfonium salts of perfluorobutanesulfonic acid, triarylsulfonium salts of perfluoroethanesulfonic acid, triarylsulfonium salts of perfluoro-octanesulfonic acid, and triarylsulfonium salts of trifluoromethane sulfonic acid. Examples of suitable triarylsulfonium salts of aryl sulfonic acids include triarylsulfonium salts of para-toluene sulfonic acid, triarylsulfonium salts of dodecylbenzene sulfonic acid, triarylsulfonium salts of benzene sulfonic acid, and triarylsulfonium salts of 3-nitrobenzene sulfonic acid. Examples of suitable diaryliodonium salts of boronic acids include diaryliodonium salts of perhaloarylboronic acids and preferred triarylsulfonium salts of boronic acids are triarylsulfonium salts of perhaloarylboronic acid.

The photoinitiator is typically used in the range of from 0.001 to 5 wt. %, based on the total weight of the curable composition. For example, the photoinitiator may be employed in an amount of 0.01 wt. % or more, such as an amount of 0.1 wt. % or more, alternatively 0.15 wt. % or more, alternatively 0.2 wt. % or more, alternatively 0.4 wt. % or more, alternatively 0.6 wt. % or more, alternatively 0.8 wt. % or more, alternatively even 1.0 wt. % or more, while at the same time typically 5 wt. % or less, alternatively 4 wt. % or less based on the total weight of the curable composition.

The curable composition is typically prepared by combining the curing agent and the silicone-polyolefin blend. The process for combining is not particularly limited, and may be performed using any of the mixing devices described above. Likewise, the curable composition may be prepared in sequence with the silicone-polyolefin blend (e.g. by adding the curing agent to the silicone-polyolefin blend upon, or soon after, formation thereof). However, it will be appreciated that a separate and/or different mixer, or mixing process, may be used to prepare the curable composition. For example, in some embodiments, the silicone-polyolefin blend is prepared as described above by dynamic crosslinking of the silicone-polyolefin composition via hot-melt extrusion, and the curing agent is then milled into the extruded silicone-polyolefin blend using a roller mill, thereby preparing the curable composition. One of skill in the art will appreciate that various mixing processes and equipment, including any of those described herein, and combinations thereof, may be utilized to combine the curing agent and the silicone-polyolefin and prepare the curable composition.

In certain embodiments, the curable composition further comprises one or more additional components, such as one or more additives. For example, in certain embodiments, the curable composition may comprise one or more additives comprising, alternatively consisting essentially of, alternatively consisting of: a filler treating agent; a binder; a thickener; a tackifying agent; an adhesion promotor; a compatibilizer; an extender; a plasticizer; an end-blocker; a drying agent; a colorant (e.g. a pigment, dye, etc.); an anti-aging additive; a biocide; a flame retardant; a corrosion inhibitor; a UV absorber; an anti-oxidant; a light-stabilizer; a catalyst (e.g. other than the catalyst (C)), procatalyst, or catalyst generator; an initiator (e.g. a heat activated initiator, an electromagnetically activated initiator, etc.); a photoacid generator; a heat stabilizer; and the like, as well as derivatives, modifications, and combinations thereof. It is to be appreciated that such additives may be classified under different terms of art and, just because an additive is classified under a specific term and/or characterized according to a particular function does not mean that it is thusly limited to that function. Moreover, some additives may be present in a particular component of the curable composition, or instead may be incorporated when forming the curable. Theoretically, the curable composition may comprise any number of additional components and additives, e.g. depending on the particular type and/or function of the same in the curable composition.

When present, the one or more additives may be combined with the curing agent or the silicone-polyolefin blend before, during, or after combining the curing agent and the silicone-polyolefin blend. Said differently, one or more of the additives may be combined with the silicone-polyolefin blend (or the curing agent) to form an intermediate composition, which is then combined with the curing agent (or the silicone-polyolefin blend) to give the curable composition. Alternatively, the silicone-polyolefin blend, the curing agent, and many of the suitable additives may be combined together in a concerted step. One of skill in the art will readily appreciate that the particular order of addition and/or combination suitable for a given additive will depend on the nature of the additive and the other components of the curable composition, and thus will be independently selected based on the particular components and parameters being employed. Likewise, it will be appreciated that certain additives (e.g. those unreactive with components (A), (B), and (C) during the preparation of the curable composition) may be introduced into the silicone-polyolefin blend during, or prior to, the compatibilization of component (B).

A cured product of the curable composition, and a method of preparing the cured product, are also provided. Specifically, the curable composition may be cured to give the cured product. As will be understood by those of skill in the art, such curing typically comprises activate curing agent, e.g. via heating the composition to a temperature sufficient to activate the radical initiator (e.g. via thermal decomposition), irradiating the photoinitiator, etc. Such activation processes are known in the art, and will be selected based on the particular curing agent utilized.

The cured product is formed via radical cure of the curable composition, i.e., upon activation of the radical initiator. It will be understood that curing the curable composition generally comprises crosslinking components thereof, such as curable organosiloxane of component (C).

As such, the method of preparing the cured product generally comprises heating the curable composition to an elevated temperature, such as a temperature of from 90 to 300, alternatively from 100 to 300, alternatively from 100 to 250, alternatively from 100 to 200° C., for a time sufficient to cure the curable composition. In some embodiments, the curable composition is cured at a temperature of from 150 to 220° C. for a time of from 1 to 20, alternatively from 5 to 20, alternatively from 5 to 15 minutes.

In view of the description above and examples below, it will be appreciated that the methods and compositions provided herein provide a cost-effective route to obtaining unique silicone-polyolefin hybrid materials due to inexpensive precursors and the solvent-less preparations. Moreover, the reactive compatibilization of the functionalized polyolefin (B) generates compatibilized graft copolymers in situ, which localizes the compatibilizer at the interface and results in an increased solvent swell resistance and tear strength. Moreover, the cured products maintain satisfactory elongation and tensile strength, exhibit improved handing and appearance characteristics, and present desirable haptics. These and other features of the cured product will be understood in view of the example below.

The following examples, illustrating embodiments of this disclosure, are intended to illustrate and not to limit the invention. Unless otherwise noted, all reactions are carried out under air, and all solvents, substrates, and reagents are purchased or otherwise obtained from various commercial suppliers (e.g. Gelest, Acros Organics, Sigma-Aldrich, etc.) and utilized as received.

### Equipment and Characterization Parameters

The following equipment and characterization procedures/parameters are used to evaluate various physical properties of the compounds prepared in the examples below.

High-Temperature Gel Permeation Chromatography (GPC): The polymer samples were analyzed on a PolymerChar GPC-IR maintained at 160° C. The sample was eluted through 1×PLgel 20 um 50×7.5 mm guard column and 4×PLgel 20 um Mixed A LS 300×7.5 mm columns with 1,2,4-trichlorobenzene (TCB) stabilized by 300 ppm of butylated hydroxyl toluene (BHT) at a flowrate of 1 mL/min. Approximately 16 mg of polymer sample was weighed out and diluted with 8 mL of TCB by the instrument. For molecular weight, a conventional calibration of polystyrene (PS) standards (Agilent PS-1 and PS-2) was used with apparent units adjusted to homo-polyethylene (PE) using known Mark-Houwink coefficients for PS and PE in TCB at this temperature. Decane was used as an internal flow marker and retention time was adjusted to this peak. For the comonomer incorporation, co-polymers of known composition were used to develop a calibration curve for incorporation.

Cure Property: Cure kinetic parameters (S′max, TC90, TS2) were measured using a Moving Die Rheometer for 10 minutes at 115° C. using methods specified in ASTM D5289.

Plasticity: Plasticity of uncured compositions were measured at 3-hour rest after milling according to ASTM D926.

Hardness: Durometer hardness of cured products was measured according to ASTM D2240.

Elastomer Properties: Tensile strength, elongation, and modulus were measured using methods described in ASTM D412; and the toughness values calculated from the same stress-strain curves thus prepared. Tear strengths were measured according to ASTM D624, Die B.

Solvent Resistance: Solvent immersion samples were produced by fully immersing die cut tensile specimen (described in ASTM D412) into specified solvent at room temperature for 72 hours. The volume changes were calculated from specific gravity measurement as described in ASTM D792 before and after the solvent immersion. Hardness, tensile strength, and elongation of samples after solvent immersion were measured using the same ASTM methods described above.

Materials

A brief summary is provided in Table 1 below, setting forth information as to certain abbreviations, shorthand notations, and components utilized in the Examples. Viscosity is typically reported as zero-shear viscosities measured at 25° C. Degree of polymerization (DP) is typically reported as number average DP, e.g. from NMR, IR, and/or GPC (e.g. relative to standards, such as polystyrene).

TABLE 1
Materials Utilized

| Component | Description |
|---|---|
| Polysiloxane (A)-1 | Diamino-functional PDMS, having an amine neutral equivalent of |
| | 6500-9000, viscosity (25° C.) of 3000-8000 cP, and a spec. gravity |
| | of 0.98 |
| Polysiloxane (A)-2 | Methacryloylpropyl-terminal PDMS, having a Mn of ~25,000, and |
| | zero shear viscosity (25° C.) of ~1000 cP |
| Polysiloxane (A)-3 | Silanol-terminal PDMS, having a DP of ~500-600, and a zero |
| | shear viscosity (25° C.) of ~13500 cP |
| Polysiloxane (A)-4 | Succinic anhydride-terminal PDMS, having a DP of ~100 |
| Polysiloxane (A)-5 | SiH-terminal PDMS, having a Mn of ~62,700 and a viscosity (25° C.) |
| | of ~10000 cP |
| Polysiloxane (A)-6 | Monocarbinol-functional PDMS, having a zero shear viscosity (25° C.) |
| | of ~250 cP |
| Polysiloxane (A)-7 | Vinyl-terminal PDMS, having a DP of ~800-1000 |
| Polysiloxane (A)-8 | Aminopropyl-terminal PDMS, having a DP of ~500-600, and a zero |
| | shear viscosity (25° C.) of ~13500 cP |
| Polyolefin (B)-1 | Maleic anhydride-grafted polyethylene, having a melt flow index |
| | of ~12 g/10 min, and an anhydride content of ~1.2 wt. % |
| Polyolefin (B)-2 | Ethylene-glycidyl methacrylate copolymer, having a melt flow index |
| | of ~5 g/10 min, a density of 0.94 g/mL, and a glycidyl methacrylate |
| | content of ~8 wt. % |
| Polyolefin (B)-3 | Amino-functional polyethylene, prepared from N-(ethyl)ethylene |
| | diamine condensation of Polyolefin (B)-1 |
| Polyolefin (B)-4 | Trimethoxysilyl-functional polyethylene, having a melt flow index |
| | of ~1.5 g/10 min and a density of 0.922 g/mL, prepared from |
| | copolymerization of ethylene with vinyltrimethoxysilane (1.5 wt. %) |
| Polyolefin (B)-5 | A copolymer of ethylene and dimethyl-7-octen-1-ylsilane having a |
| | molecular weight (Mn) of 9 kDa, polydispersity index of 2.7 and |
| | containing about 4.3 wt. % silane monomer |
| Silicone Base (C)-1 | 40 durometer silicone rubber (HCR) base |
| Catalyst (D)-1 | Tris(pentafluorophenyl)borane (FAB), utilized as a 45 mg/ml |
| | solution in toluene |
| Catalyst (D)-2 | A Karstedt's Catalyst complex, comprising a mixture of a |
| | platinum(IV) complex of 1,3-diethenyl-1,1,3,3-tetramethyldisiloxane |
| | (1 wt. %), a dimethylvinylsiloxy-terminated polydimethylsiloxane |
| | having a viscosity of ~0.45 Pa-s at 25° C. (92 wt. %), and |
| | tetramethyldivinyldisiloxane (7 wt. %) |
| Catalyst (D)-3 | Titanium(IV) bis(acetylacetonate) diisopropoxide |
| | (Ti(OiPr)₂(acac)₂); utilized as a 90 mg/mL solution in toluene |
| | (prepared from 75% in iPrOH solution) |
| Cure Agent | 50 wt. % Bis-(2,4-dichlorobenzoyl)peroxide in silicone gum (STIT) |
| Solvent 1 | Volatile polydimethylcyclosiloxane fluid, primarily composed of |
| | cyclopentasiloxane |
| Solvent 2 | Toluene, HPLC grade |
| Solvent 3 | Oleic Acid, technical grade, 90% |
| Solvent 4 | Ethanol, 200 proof (anhydrous) |

General Procedure for Preparing Hybrid Elastomer Base

Equipment: Hybrid elastomer bases were prepared in a 50 cc Haake Rheomix OS system (Haake Bowl) with roller rotors driven and controlled by a PolyoLab OS system.

Synthesis: The bowl was heated to 180° C. and the rotors were set to 75 rpm. Silicone Base (C)-1 was added to the bowl in portions under a flow of N₂, followed by Polyolefin (B)-1. After approximately 1 minute of blending a smooth white mixture is obtained. A Polysiloxane (A) was added and blending continued for 5 minutes then the product was emptied onto a steel tray and allowed to cool.

Curing Elastomers: A polished stainless steel mold with internal cavity dimensions of 6″ by 6″ by 2 mm was conditioned by covering the interior surfaces with a Teflon release coating spray. A curable composition was prepared by blending the hybrid elastomer base with the Cure Agent (1 part per one hundred (pph) parts of hybrid elastomer base, by weight) directly on the two-roll mill until the resulting mass is visually homogeneous, which was then divided up into portions to fill 110% of a mold with internal cavity dimension of 6″ by 6″ by 2 mm. The individual portion of formulated compound was preformed into a flat sheet that is slightly smaller than 6″ by 6″, placed in the mold at room temperature. The compounds were compression molded in a heated hydraulic press at 115° C. and 1500 psi for 10 minutes and removed from the mold immediately after cure. The cured hybrid elastomer sheets were rested at room temperature for 24 hours before characterization.

### EXAMPLES 1-10 AND COMPARATIVE EXAMPLES 1-4

### Preparation of Examples 1-10 and Comparative Example 1

Synthesis of the hybrid elastomer base was performed according to the general procedure above. The procedure was repeated to produce sufficient material for a given test. The particular components, parameters, and properties of material obtained for Examples 1-10 and Comparative Example 1 are shown in Tables 2-3 below.

### Comparative Example 2

Comparative Example 2 was prepared solely with Silicone Base (C)-1. The particular components, parameters, and properties of material obtained for Comparative Example 2 are shown in Table 3 below.

### Comparative Examples 3-4

Comparative Examples 3-4 were prepared by blending Silicone Base (C)-1 and Polysiloxane (A) directly on a two-roll mill until the resulting mass is visually homogeneous. The particular components, parameters, and properties of material obtained for Comparative Examples 3-4 are shown in Table 3 below.

TABLE 2
Components and Parameters of Examples 1-7

| Example: | 1 | 2 | 3 | 4 | 5 | 6 | 7 |
|---|---|---|---|---|---|---|---|
| Silicone Base (C)-1[g]: | 40 | 34 | 38.2 | 35 | 38 | 40 | 34 |
| Silicone Base (C)-1 [wt. %]: | 89 | 76 | 85.1 | 80 | 84 | 89 | 76 |
| Polyolefin (B)-1 [g]: | 4.4 | 8.4 | 4.24 | 8.8 | 5.8 | 4.4 | 8.5 |
| Polyolefin (B)-1 [wt. %]: | 9.9 | 19 | 9.9 | 19 | 13 | 9.9 | 19 |
| Polysiloxane (A)-1 [g]: | — | — | — | — | — | 0.5 | 2.2 |
| Polysiloxane (A)-8 [g]: | 0.5 | 2.2 | 2.24 | 0.4 | 1.3 | — | — |
| Polysiloxane (A) [wt. %]: | 1 | 5 | 5 | 1 | 3 | 1 | 5 |
| S'max [lb-in]: | 11 | 12 | 10 | 12 | 11 | 11 | 11 |
| TC90 [s]: | 85 | 93 | 85 | 104 | 98 | 82 | 99 |
| TS2 [s]: | 28 | 26 | 29 | 29 | 29 | 28 | 28 |
| Hardness [Shore A]: | 46 | 54 | 44.5 | 55 | 47 | 47 | 55 |
| Tensile Strength [MPa]: | 5.6 | 6.3 | 6.44 | 3.8 | 6.9 | 5.4 | 7.7 |
| Elongation [%]: | 405 | 322 | 420 | 249 | 417 | 321 | 384 |
| 100% Modulus [MPa]: | 1.2 | 2.1 | 1.21 | 2.2 | 1.3 | 1.4 | 2.3 |
| Toughness [J/m³]: | 10.9 | 15.3 | 12.5 | 3.8 | 13.4 | 8.5 | 15.6 |
| Tear B [ppi]: | 56.5 | 74.0 | 144.1 | 74.6 | 72.0 | 62.4 | 87.3 |
| Plasticity [3 hr]: | 74 | 105 | 88 | 82 | 87 | 73 | 102 |

TABLE 3
Components and Parameters of Examples 8-10 & Comp. Examples 1-4

| Example: | 8 | 9 | 10 | CE1 | CE2 | CE3 | CE4 |
|---|---|---|---|---|---|---|---|
| Silicone Base (C)-1[g]: | 38.2 | 35.3 | 37.5 | 35.6 | 145.5 | 145.5 | 145.5 |
| Silicone Base (C)-1 [wt. %]: | 85.1 | 80 | 84.1 | 80 | 100 | 97 | 97 |
| Polyolefin (B)-1 [g]: | 4.24 | 8.83 | 5.77 | 8.9 | 0 | 0 | 0 |
| Polyolefin (B)-1 [wt. %]: | 9.9 | 19 | 12.9 | 20 | 0 | 0 | 0 |
| Polysiloxane (A)-1 [g]: | 2.24 | 0.44 | 1.34 | — | — | — | 4.5 |
| Polysiloxane (A)-8 [g]: | — | — | — | — | — | 4.5 | — |
| Polysiloxane (A) [wt. %]: | 5 | 1 | 3 | — | — | 3 | 3 |
| S'max [lb*in]: | 10 | 12 | 11 | 12 | 10 | 10 | 9 |
| TC90 [s]: | 85 | 98 | 82 | 97 | 61 | 72 | 66 |
| TS2 [s]: | 29 | 29 | 26 | 30 | 27 | 28 | 29 |
| Hardness [Shore A]: | 47.8 | 54.7 | 49.9 | 55 | 40.1 | 37.3 | 34.5 |
| Tensile Strength [MPa]: | 6.52 | 4.39 | 5.98 | 3.56 | 5.98 | 4.15 | 4.78 |
| Elongation [%]: | 419 | 308 | 315 | 363 | 419 | 421 | 458 |
| 100% Modulus [MPa]: | 1.54 | 2.14 | 1.46 | 1.48 | 1 | 0.85 | 0.74 |
| Toughness [J/m³]: | 13.3 | 9.2 | 8.8 | 5.9 | 10.3 | 12.3 | 7.4 |
| Tear B [ppi]: | 93.4 | 68.8 | 75.0 | 52.7 | 45.5 | 42.0 | 54.6 |
| Plasticity [3 hr]: | 91 | 77 | 85 | 72 | 59 | 60 | 77 |

The products obtained from Examples 7-8 and Comparative Examples 1-2 were evaluated for solvent resistance according to the procedures above using Solvents 1-4. The results of the evaluations are set forth in Table 4 below. Results are reported as % change (A) following 72 hours of immersion in the indicated solvent.

TABLE 4
Solvent Resistance Results for Examples
7-8 and Comp. Examples 1-2

| Example: | | 7 | 8 | CE1 | CE2 |
|---|---|---|---|---|---|
| Solvent 1 | Volume: | 159.84 | 195.84 | 165.71 | 237.28 |
| | Hardness/Durometer: | −31.31 | −35.56 | −50.82 | −42.86 |
| | Tensile Strength: | −81.61 | −90.49 | −67.98 | N/A |
| | Elongation: | −86.24 | −91.9 | −77.69 | N/A |
| Solvent 2 | Volume: | 142.63 | 172.56 | 122.39 | 211.59 |
| | Hardness/Durometer: | −34.99 | −40.59 | −43.9 | −42.06 |
| | Tensile Strength: | −46.85 | −75.56 | −65.17 | N/A |
| | Elongation: | −65.87 | −77.68 | −73.83 | N/A |
| Solvent 3 | Volume: | 12.81 | 13.66 | 14.38 | 8.75 |
| | Hardness/Durometer: | −11.97 | −14.64 | −18.03 | −17.46 |
| | Tensile Strength: | −8.06 | −18.27 | −24.44 | −20.3 |
| | Elongation: | −5.56 | −31.73 | −17.08 | −9.26 |
| Solvent 4 | Volume: | 2.51 | 2.57 | 15.12 | 5.06 |
| | Hardness/Durometer: | −4.24 | −10.88 | −5.28 | −5.82 |
| | Tensile Strength: | −13.35 | −22.59 | −31.18 | −22.13 |
| | Elongation: | −4.23 | −12.69 | −26.45 | −11.07 |

For comparative Example 2, “N/A” indicates an unmeasurable property due to insufficient mechanical integrity of the sample, preventing effective mounting and evaluation post-immersion.

### Examples 11-19

### Preparation of Examples 11-19

Synthesis of the hybrid elastomer base was performed in accordance with the general procedure above. Specifically, the Silicone Base (C)-1 (33.8 g, 76 wt. %) was added to the bowl in portions under a flow of N₂, followed by a Polyolefin (B) (8.45 g, 19 wt. %) as listed in the table. After approximately 1 minute of blending a smooth white mixture is obtained. The Polysiloxane (A) (2.22 g, 5.0 wt. %) was added as indicated in the table. In some cases, a Catalyst (D) was added as specified in the table. After the final addition, blending continued for 5 minutes then the product was emptied onto a steel tray and allowed to cool. Procedure was repeated to produce sufficient material for a given test.

For Example 14, the following component amounts were utilized: 0.42 g Polysiloxane (A) (1.0 wt. %); 33.8 g Silicone Base (C)-1 (80 wt. %).

The particular components, parameters, and properties of material obtained for Examples 11-19 are shown in Table 5 below.

TABLE 5
Components and Parameters of Examples 11-19

| Example: | 11 | 12 | 13 | 14 | 15 | 16 | 17 | 18 | 19 |
|---|---|---|---|---|---|---|---|---|---|
| Polysiloxane (A): | (A)-1 | (A)-2 | (A)-3 | (A)-4 | (A)-5 | (A)-6 | (A)-7 | (A)-8 | (A)-6 |
| Polyolefin (B): | (B)-2 | (B)-3 | (B)-4 | (B)-3 | (B)-4 | (B)-4 | (B)-5 | (B)-5 | (B)-1 |
| Catalyst (D): | — | — | — | — | (D)-1 | (D)-2 | (D)-3 | (D)-1 | — |
| Cure Agent (pph): | 1 | 2 | 1 | 2 | 1 | 1 | 1 | 1 | 1 |
| Cure Time [min]: | 10 | 20 | 10 | 10 | 10 | 10 | 10 | 10 | 10 |
| Hardness [Shore A]: | 42.8 | 20.1 | 49.3 | 36.8 | 50.3 | 49.0 | 54.1 | 50.2 | 47.2 |
| Tensile Strength [MPa]: | 3.07 | 2.06 | 7.25 | 4.65 | 7.02 | 4.99 | 6.59 | 3.29 | 2.66 |
| Elongation [%]: | 478 | 572 | 439 | 631 | 430 | 419 | 367 | 389 | 398 |
| 100% Modulus [MPa]: | 1.09 | 0.5 | 1.62 | 0.83 | 1.91 | 1.55 | 1.92 | 1.49 | 1.14 |
| Toughness [J/m³]: | 10.5 | 6.8 | 15.1 | 16.0 | 15.9 | 14.4 | 11.6 | 8.5 | 6.0 |

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A silicone-polyolefin composition, comprising:
(A) a polysiloxane comprising an average of at least one functional group X per molecule;
(B) a functionalized polyolefin comprising an average of at least one functional group Y per molecule, where the functional group Y is reactable with the functional group X of the polysiloxane (A) to form a bond therebetween; and
(C) a curable silicone elastomer component.

2. The silicone-polyolefin composition of claim 1, wherein the polysiloxane (A) has the following average unit formula:
[XₘR¹₃₋ₘSiO_{1/2}]ₐ[XₙR¹₂₋ₙSiO_{2/2}]_{b},
where X is the functional group defined above, each R¹ is an independently selected hydrocarbyl group, subscript m is independently 1 or 0 in each moiety indicated by subscript a, subscript n is independently 1 or 0 in each moiety indicated by subscript b, and subscripts a and b are each mole fractions such that a+b=1, with the provisos that 0<a<1, 0<b<1, and the polysiloxane (A) comprises at least one functional group X.

3. The silicone-polyolefin composition of claim 1, wherein: (i) each functional group X comprises an aminoalkyl group, a methacryloxy group, a silicon-bonded hydroxyl group, an anhydride group, a silicon-bonded hydrogen atom, an olefinically-unsaturated group, or a carbinol group; (ii) the polysiloxane (A) comprises at least one terminal functional group X; or (iii) both (i) and (ii).

4. The silicone-polyolefin composition of claim 1, wherein the polysiloxane (A): (i) exhibits a viscosity of at least 500 cP at 25° C.; (ii) has a degree of polymerization (DP) of from 50 to 1200; (iii) is present in the silicone-polyolefin composition in an amount of from 1 to 30 wt. %, based on the total weight of the silicone-polyolefin composition; or (iv) any combination of (i)-(iii).

5. The silicone-polyolefin composition of claim 1, wherein: (i) the functionalized polyolefin (B) comprises a functionalized polyethylene (PE), polypropylene (PP), or polyethylene-alpha olefin copolymer; (ii) each functional group Y comprises an epoxide group, an aminoalkyl group, a trimethoxysilyl group, a hydridosilyl group, or an anhydride group; or (iii) both (i) and (ii).

6. The silicone-polyolefin composition of claim 1, wherein the functionalized polyolefin (B): (i) has a density of from 0.86-0.96 g/cm³; (ii) is functionalized with from 0.05 to 10 wt. % of functional moieties comprising the functional group Y, based on the total weight of the functionalized polyolefin (B); (iii) is present in the silicone-polyolefin composition in an amount of from 1 to 50 wt. %, based on the total weight of the silicone-polyolefin composition; or (v) any combination of (i)-(iv).

7. The silicone-polyolefin composition of claim 1, wherein the curable silicone elastomer component (C) comprises: (i) a reaction-curable organosiloxane; (ii) a silica; or (iii) both (i) and (ii).

8. The silicone-polyolefin composition of claim 7, wherein the curable silicone elastomer component (C) comprises the reaction-curable organosiloxane; and wherein the reaction-curable organosiloxane: (i) is further defined as a polydiorganosiloxane gum; (ii) comprises olefinic unsaturation; or (iii) both (i) and (ii).

9. The silicone-polyolefin composition of claim 1, wherein the curable silicone elastomer component (C): (i) is present in the silicone-polyolefin composition an amount of from 20 to 98 wt. %, based on the total weight of the silicone-polyolefin composition; (ii) is immiscible with the functionalized polyolefin (B); or (iii) both (i) and (ii).

10. The silicone-polyolefin composition of claim 1, further comprising: (i) (D) a catalyst adapted to facilitate a coupling reaction between the functional group X of the polysiloxane (A) and functional group Y of the functionalized polyolefin (B); (ii) a reaction inhibitor; or (iii) both (i) and (ii).

11. The silicone-polyolefin composition of claim 9, wherein the silicone-polyolefin composition comprises the catalyst (D), and wherein the catalyst (D): (i) is selected from hydrosilylation catalysts, condensation catalysts, Lewis Acid catalysts, Piers-Rubinsztajn-type catalysts, and combinations thereof; (ii) is present in the silicone-polyolefin composition in an amount of from 1 to 100 ppm; or (iii) both (i) and (ii).

12. The silicone-polyolefin composition of claim 1, wherein the silicone-polyolefin composition: (i) is free from a carrier vehicle; (ii) is free from a reaction catalyst or promotor; (iii) is further defined as a polyolefin-in-silicone dispersion; or (iv) any combination of (i)-(iii).

13. A method of preparing a silicone-polyolefin blend, said method comprising:
combining the polysiloxane (A), the functionalized polyolefin (B), and the curable silicone elastomer component (C) to prepare the silicone-polyolefin composition of claim 1; and
reacting the polysiloxane (A) and the functionalized polyolefin (B) in the presence of the curable silicone elastomer component (C), thereby preparing the silicone-polyolefin blend.

14. The method of claim 13, wherein reacting the polysiloxane (A) and the functionalized polyolefin (B) in the presence of the curable silicone elastomer component (C): (i) comprises melt blending the silicone-polyolefin composition at a temperature greater than the melting point of the functionalized polyolefin (B); (ii) comprises extruding the silicone-polyolefin composition; (iii) is carried out under substantially solvent-free conditions; (iv) is carried out in the presence of a catalyst adapted to facilitate a coupling reaction between the functional group X of the polysiloxane (A) and functional group Y of the functionalized polyolefin (B); or (v) any combination of (i)-(iv).

15. A silicone-polyolefin blend prepared according to the method of claim 13.

16. A curable composition, comprising the silicone-polyolefin blend of claim 15 and a curing agent.

17. The curable composition of claim 15, wherein: (i) the curing agent comprises a radical initiator and/or a photoinitiator; (ii) the curable composition is free from a carrier vehicle; or (iii) both (i) and (ii).

18. A method of preparing a cured product, said method comprising curing the curable composition of claim 16, thereby preparing the cured product.

19. The method of claim 18, wherein the curing agent comprises a radical initiator, and wherein curing the curable composition comprises heating the curable composition to a temperature sufficient to activate the radical initiator via thermal decomposition.

20. A cured product of the curable composition of claim 16.
